(19) United States
(12) Patent Application Publication
(10) Pub. No.: US 2023/0062121 A1
(43) Pub. Date: Mar. 2, 2023

(54) CLAMPING ARRANGEMENTS FOR ASSEMBLING FURNITURE

(71) Applicant: POPPIN, INC., New York, NY (US)

(72) Inventors: Jeffrey F. MILLER, New York, NY (US); Adrian GOMEZ, Edgewater, NJ (US)

(73) Assignee: POPPIN, INC., New York, NY (US)

(21) Appl. No.: 17/760,349

(22) PCT Filed: Feb. 11, 2020
(86) PCT No.: PCT/US2020/017670

§ 371 Date: Aug. 8, 2022

(51) Int. Cl. A47B 13/00; A47B 13/08; F16B 2/18

(52) U.S. Cl. CPC A47B 13/003; A47B 13/088; F16B 2/185; A47B 3/06

(57) ABSTRACT

Clamping arrangements for assembling components of modular furniture are disclosed. The clamping arrangements can include a frame comprising a cavity intermediate opposing sidewall surfaces. The clamping arrangements can also include a spring positioned in the cavity, wherein the spring comprises a folded metal sheet. The clamping arrangements can also include a lever comprising a camming surface, wherein the lever is pivotably coupled to the first sidewall and the second sidewall about an axis of rotation and pivotable between an unclamped position and a clamped position. The camming surface can be configured to directly engage the spring and deform the spring to a clamping configuration when the lever is in the clamped position.

### FIELD

The present disclosure relates to clamping arrangements for assembling furniture such as tables and desks.

### BACKGROUND

Furniture can be a large investment. Moreover, an individual or company's furniture needs may change over time. Furniture that is easy to assemble/disassemble and/or modular can be convenient for the evolving needs of an individual and/or company. For example, it may be convenient to add-on additional furniture modules to a desk collection in an office environment. Furthermore, it can be convenient to move and/or redistribute the furniture modules in the desk collection when a company relocates, grows, and/or downsizes.

### SUMMARY

In one aspect, a clamping arrangement comprising a frame, a spring, a lever, and an elongate support is disclosed. The frame comprises a first sidewall having a first through-hole, a second sidewall having a second through-hole, and a cavity intermediate the first sidewall and the second sidewall. The first through-hole and the second through-hole are axially aligned. The spring is positioned in the cavity. The spring comprises a folded sheet. The lever is pivotably coupled to the first sidewall and the second sidewall and pivotable between an unclamped position and a clamped position. The lever comprises a camming surface configured to deform the spring when in the clamped position. The elongate support extends through the first through-hole and the second through-hole. The spring is configured to clamp the elongate support when the lever is in the clamped position. The spring is configured to release the elongate support when the lever is in the unclamped position.

In one aspect, a clamping arrangement comprising a frame, a spring, a lever, and an elongate support is disclosed. The frame comprises a first sidewall having a first cutout, a second sidewall having a second cutout, and a cavity intermediate the first sidewall and the second sidewall. The first cutout and the second cutout are axially aligned. The spring is positioned in the cavity. The spring comprises a folded sheet. The lever is pivotably coupled to the first sidewall and the second sidewall and pivotable between an unclamped position and a clamped position. The lever comprises a camming surface configured to deform the spring when in the clamped position. The elongate support extends through the first cutout and the second cutout. The spring is configured to clamp the elongate support when the lever is in the clamped position. The spring is configured to release the elongate support when the lever is in the unclamped position.

In one aspect, a clamping arrangement comprising a frame, a spring, and a lever is disclosed. The frame comprises a first sidewall having a first through-hole, a second sidewall having a second through-hole, and a cavity intermediate the first sidewall and the second sidewall. The first through-hole and the second through-hole are axially aligned. The spring is positioned in the cavity. The spring comprises a folded metal sheet. The lever comprises a camming surface. The lever is pivotably coupled to the first sidewall and the second sidewall about an axis of rotation and pivotable between an unclamped position and a clamped position. The lever is configured to pivot through a peak orthogonal distance from the axis of rotation to the camming surface when the lever is moved between the unclamped position and the clamped position. The camming surface is configured to directly engage the spring and deform the spring to a clamping configuration when the lever is in the clamped position.

### DRAWINGS

Features of various aspects are set forth with particularity in the appended claims. The described aspects, however, both as to organization and methods of operation, may be best understood by reference to the following description, taken in conjunction with the accompanying drawings.

FIG. 1 is a table depicting components of a kit for assembling a piece of furniture, in accordance with at least one aspect of the present disclosure.

FIG. 2 is a perspective view of the piece of furniture assembled with the kit of FIG. 1, in accordance with at least one aspect of the present disclosure.

FIGS. 3-8 are perspective views depicting steps for assembling the piece of furniture of FIG. 2 from the kit of FIG. 1, in accordance with at least one aspect of the present disclosure.

FIG. 9 is a table depicting components of a kit for assembling a piece of furniture, in accordance with at least one aspect of the present disclosure.

FIG. 10 is a perspective view of the piece of furniture assembled with the kit of FIG. 9, in accordance with at least one aspect of the present disclosure.

FIG. 11 is a table depicting components of a kit for assembling a piece of furniture, in accordance with at least one aspect of the present disclosure.

FIG. 12 is a perspective view of the piece of furniture assembled with the kit of FIG. 11, in accordance with at least one aspect of the present disclosure.

FIGS. 13-21 are perspective views depicting steps for assembling the piece of furniture of FIG. 12 from the kit of FIG. 11, in accordance with at least one aspect of the present disclosure.

FIG. 22 is a table depicting components a kit for assembling a piece of furniture, in accordance with at least one aspect of the present disclosure.

FIG. 23 is a perspective view of the piece of furniture assembled with the kit of FIG. 22, in accordance with at least one aspect of the present disclosure.

FIG. 24 is a perspective view of a trestle clamp arrangement with certain portions depicted as transparent for illustrative purposes, and further depicting the trestle clamp arrangement in an unclamped configuration relative to an elongate support, in accordance with at least one aspect of the present disclosure.

FIG. 25 is a perspective view of the trestle clamp arrangement of FIG. 24 with certain portions depicted as transparent for illustrative purposes, and further depicting the trestle clamp arrangement in a clamped configuration relative to the elongate support, in accordance with at least one aspect of the present disclosure.

FIG. 26 is an exploded perspective view of a trestle assembly and a locking spring of the trestle clamp arrangement of FIG. 24 with certain portions depicted as transparent for illustrative purposes, in accordance with at least one aspect of the present disclosure.

FIG. 27 is a perspective view of the trestle assembly and the locking spring of FIG. 26 installed in the trestle assembly with certain portions depicted as transparent for illustrative purposes, in accordance with at least one aspect of the present disclosure.

FIG. 28 is a partially-exploded perspective view of a trestle assembly, a locking spring, and a locking lever of the trestle clamp arrangement of FIG. 24 with certain portions depicted as transparent for illustrative purposes, in accordance with at least one aspect of the present disclosure.

FIG. 29 is a perspective view of the trestle assembly, the locking spring, and the locking lever of FIG. 28 in a partially-assembled, intermediate position and with certain portions depicted as transparent for illustrative purposes, in accordance with at least one aspect of the present disclosure.

FIG. 30 is a perspective view of the trestle assembly, the locking spring, and the locking lever of FIG. 28 in an assembled position and with certain portions depicted as transparent for illustrative purposes, in accordance with at least one aspect of the present disclosure.

FIG. 31 is a perspective view of a table top clamp arrangement in an unclamped configuration relative to an elongate support, in accordance with at least one aspect of the present disclosure.

FIG. 32 is a perspective view of the table top clamp arrangement of FIG. 31 in a clamped configuration relative to the elongate support, in accordance with at least one aspect of the present disclosure.

FIG. 33 is an exploded perspective view of a bracket and a spring of the table top clamp arrangement of FIG. 31, in accordance with at least one aspect of the present disclosure.

FIG. 34 is a perspective view of the spring installed in the bracket of FIG. 33, in accordance with at least one aspect of the present disclosure.

FIG. 35 is a partially-exploded perspective view of the table top clamp arrangement of FIG. 31, depicting a pin separated from the table top clamp arrangement along an axis, in accordance with at least one aspect of the present disclosure.

FIG. 36 is a perspective view of the table top clamp arrangement of FIG. 35, in accordance with at least one aspect of the present disclosure.

FIG. 37 is a perspective view of a locking lever, in accordance with at least one aspect of the present disclosure.

FIG. 38 is a side view of the locking lever of FIG. 37 with the locking spring and the elongate support of FIG. 24, depicting the locking lever and the locking spring in an unclamped configuration relative to the elongate support, in accordance with at least one aspect of the present disclosure.

FIG. 39 is a side view of the locking lever, the locking spring, and the elongate support of FIG. 38, depicting the locking lever and the locking spring in a clamped configuration relative to the elongate support, in accordance with at least one aspect of the present disclosure.

FIG. 40 is a perspective view of a locking lever, in accordance with at least one aspect of the present disclosure.

FIG. 41 is a side view of the locking lever of FIG. 40 with the locking spring and the elongate support of FIG. 31, depicting the locking lever and the locking spring in an unclamped configuration relative to the elongate support, in accordance with at least one aspect of the present disclosure.

FIG. 42 is a side view of the locking lever, the locking spring, and the elongate support of FIG. 41, depicting the locking lever and the locking spring in a clamped configuration relative to the elongate support, in accordance with at least one aspect of the present disclosure.

FIG. 43 is a perspective view of a piece of furniture, in accordance with at least one aspect of the present disclosure.

FIG. 44 is another perspective view of the piece of furniture of FIG. 43, in accordance with at least one aspect of the present disclosure.

FIG. 44A is a detail view of FIG. 44, in accordance with at least one aspect of the present disclosure.

FIG. 45 is a perspective view of an end cap of the piece of furniture of FIG. 43, in accordance with at least one aspect of the present disclosure.

Corresponding reference characters indicate corresponding parts throughout the several views. The exemplifications set out herein illustrate various embodiments of the invention, in one form, and such exemplifications are not to be construed as limiting the scope of the invention in any manner.

### DESCRIPTION

Before explaining various aspects of clamping arrangements in detail, it should be noted that the illustrative examples are not limited in application or use to the details of construction and arrangement of parts illustrated in the accompanying drawings and description. The illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof. Also, it will be appreciated that one or more of the following-described aspects, expressions of aspects, and/or examples, can be combined with any one or more of the other following-described aspects, expressions of aspects, and/or examples.

Furniture is often assembled and disassembled by users at least once during its lifetime. Some pieces of furniture may be at least partially disassembled and reassembled multiple times. For example, new furniture may arrive at least partially unassembled, and can require at least some assembly by the user. Additionally, when furniture is moved, at least partial disassembly of the furniture may be necessary or desired because the broken-apart components of the furniture may be easier to package, ship, and/or carry, for example.

Assembly, disassembly, and/or re-assembly of the furniture can be toolless and facilitated with clamping arrangements that offer robust and secure holds throughout the lifetime of the furniture and/or components thereof.

In certain instances, the clamping arrangements can consist of only two components—a pivotable locking lever and a deformable locking spring—which can interact to directly engage the rounded or contoured perimeter of an elongate support and secure the elongate support to a frame.

Moreover, the clamping arrangements can be incorporated into a furniture components such that it is effectively concealed from view when the components are clamped together and the piece of furniture is fully assembled.

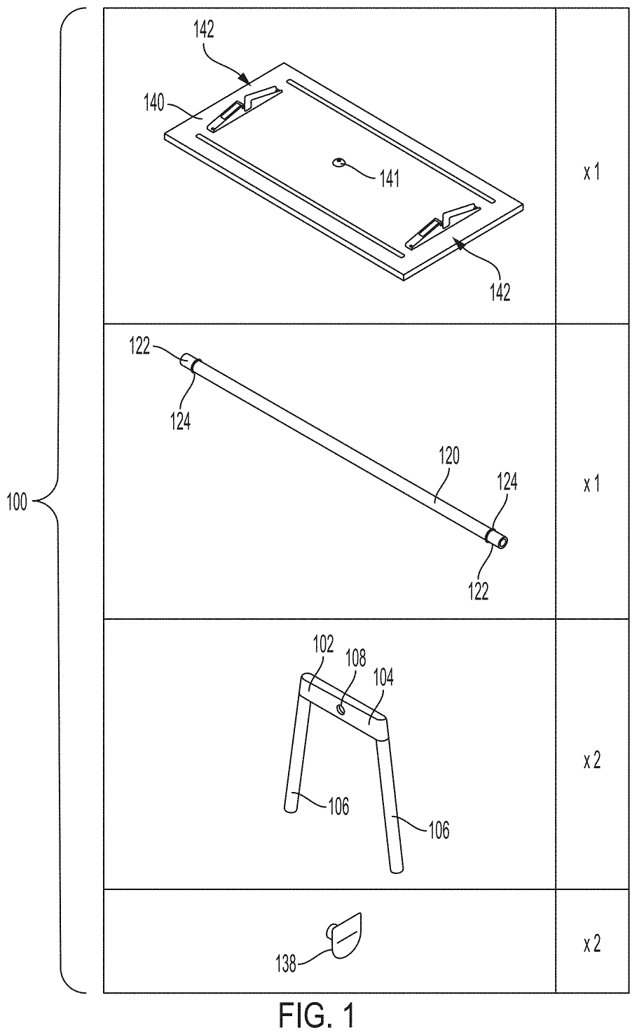

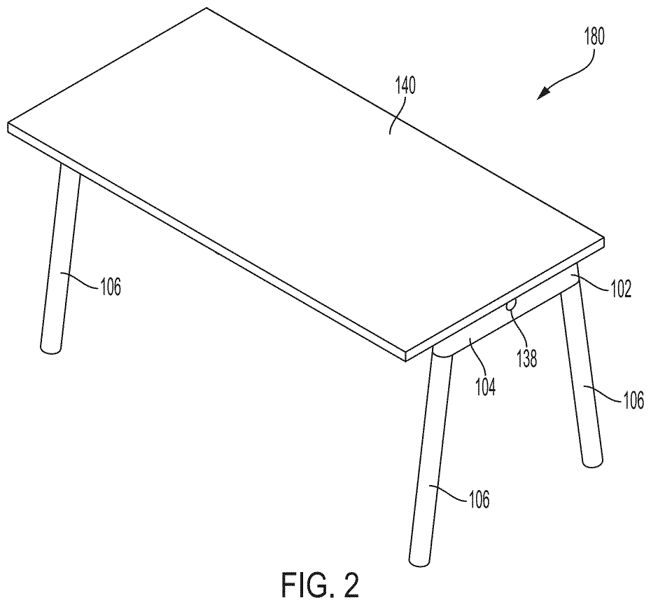

Referring to FIGS. 1 and 2, a kit 100 (FIG. 1) for assembling a piece of furniture 180 (FIG. 2) is shown. The piece of furniture 180 can be used as a desk or table. In other words, the kit 100 can be a system for assembling a desk or a table. The kit 100 includes two trestle assemblies 102, one elongate support 120, two end caps 138, and one table top 140. The various components can be assembled and clamped together, as further described herein. As further described herein, the kit 100 can be expanded to include additional and/or duplicative components to facilitate expansion of the piece of furniture 180. For example, a desk or table can be expanded with additional table tops 140, as further described herein, to accommodate additional people.

The trestle assembly 102 includes a horizontal frame member 104 extending between two opposing legs 106. Each of the legs 106 can extend from an end of the horizontal frame member 104, for example. When the piece of furniture 180 is assembled, the horizontal frame member 104 can be positioned horizontally and can be parallel relative to a level support surface, such as a floor, for example. The legs 106 can be positioned vertically or obliquely-oriented relative to the horizontal frame member 104, which can span the space between the two legs 106. The horizontal frame member 104 includes an aperture or through-hole 108 dimensioned to receive an end portion 122 of the elongate support 120. The through-hole 108 is equidistantly-spaced on the horizontal frame member 104 between the legs 106. In such instances, the trestle assembly 102 is symmetric relative to an axis extending through the through-hole 108 equidistant between the legs 106.

The elongate support 120 comprises a hollow, cylindrical beam having opposing end portions 122. In other instances, the elongate support 120 may be a solid cylindrical beam. Each end portion 122 is defined between a ridge 124 and the adjacent end of the elongate support 120. The ridge 124 can extend around, or at least partially around, the perimeter of the elongate support 120. The ridge 124 can comprise a protrusion and/or blocking surface for facilitating assembly of the piece of furniture 180, as further described herein. The elongate support 120 is a furniture-supporting cross beam. For example, the elongate support 120 can support a table top positioned thereon and clamped thereto, as further described herein.

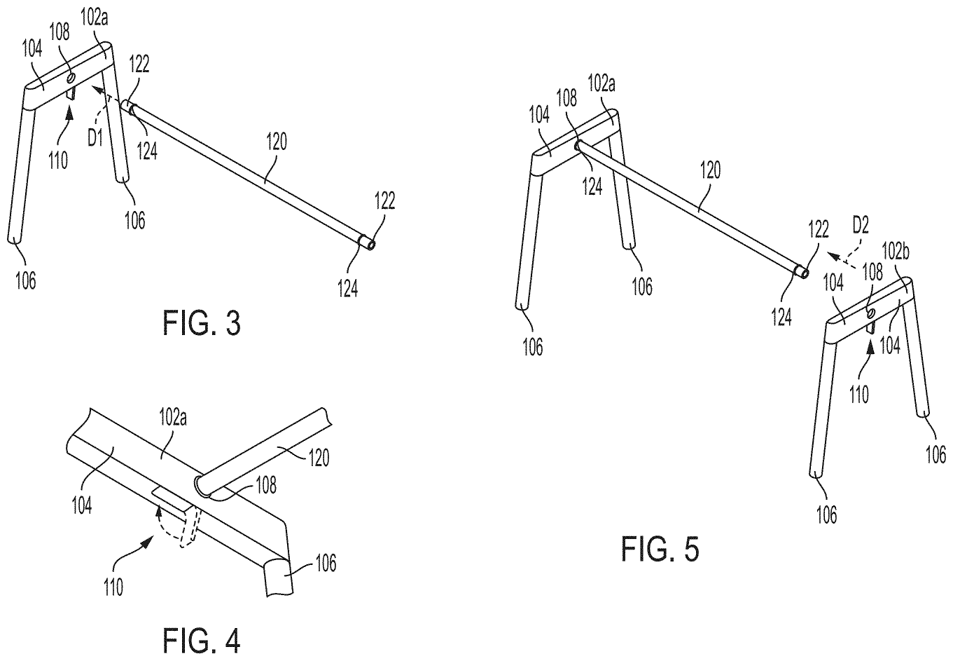

An example assembly sequence for the piece of furniture 180 is shown in FIGS. 3-8. For example, two trestle assemblies 102a, 102b are connected to the elongate support 120 in FIGS. 3-5. To connect the elongate support 120 to the trestle assemblies 102a, 102b, the longitudinal axis of the elongate support 120 can be aligned with the through-hole 108 in the horizontal frame member 104 of the first trestle assembly 102a (FIG. 3). The elongate support 120 can be moved in the direction D1 to move the end portion 122 into the through-hole 108 until the ridge 124 is pressed against, i.e., in abutting contact with, the horizontal frame member 104. After the end portion 122 of the elongate support 120 is seated in the through-hole 108 of the first trestle assembly 102a, a trestle clamp 110 can be actuated (FIG. 4) to securely clamp or lock the elongate support 120 to the first trestle assembly 102a. Similarly, the longitudinal axis of the elongate support 120 can be aligned with the through-hole 108 in the horizontal frame member 104 of the second trestle assembly 102b (FIG. 5). The second trestle assembly 102b can be moved in the direction D2 such that the end portion 122 extends into the through-hole 108 and the ridge 124 is pressed against, i.e., in abutting contact with, the horizontal frame member 104. After the end portion 122 of the elongate support 120 is seated in the through-hole 108 of the second trestle assembly 102b, the trestle clamp 110 of the second trestle assembly 102b can be actuated to securely clamp or lock the elongate support 120 to the second trestle assembly 102b.

Example trestle clamps are further described herein and in U.S. Pat. No. 10,231,537, titled DESK SYSTEM WITH EXPANDABLE BENCHING, issued Mar. 19, 2019, which is incorporated by reference herein in its entirety.

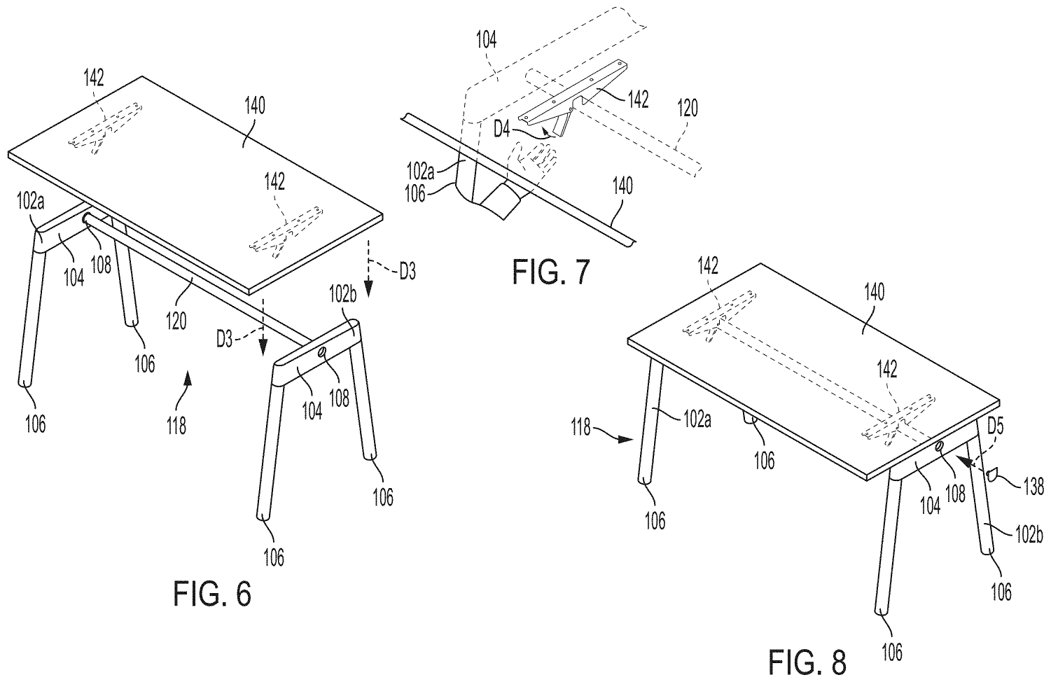

Referring primarily to FIG. 6, the connected trestle assemblies 102a, 102b and the elongate support 120 can form a sawhorse portion 118 of the piece of furniture 180 (FIG. 2). The table top 140 can then be secured to the sawhorse portion 118. The table top 140 includes two table top clamps 142 on the underside of the table top 140 for locking the elongate support 120 to the table top 140. Referring again to FIG. 1, the table top 140 also includes a touchdown bumper 141 on the underside of the table top 140 for engaging the elongate support 120. For example, the elongate support 120 can support the table top 140 at one of more touchdown bumpers 141 along the length of the elongate support 120 and/or intermediate two table top clamps 142. The touchdown bumpers 141 are circular. In other instances, the touchdown bumpers 141 can be pill-shaped.

The table top 140 can be positioned over the sawhorse portion 118 such that the table top clamps 142 and the touchdown bumpers 141 are aligned with the elongate support 120. The table top 140 can then be moved in the direction D3 to lower the table top 140 onto the elongate support 120. After the table top 140 is positioned on the elongate support 120, the table top clamps 142 can be actuated by pivoting the actuation levers in the direction D4 (FIG. 7) to secure the table top 140 to the elongate support 120.

Example table top clamps are further described herein and in U.S. Pat. No. 10,231,537, titled DESK SYSTEM WITH EXPANDABLE BENCHING, issued Mar. 19, 2019, which is incorporated by reference herein in its entirety.

Referring primarily to FIG. 8, end caps 138 can be positioned in the through-holes 108 to close or seal the through-holes 108 and provide a clean, smooth, and aesthetically-pleasing appearance. For example, the end caps 138 can be moved in the direction D5 to be positioned at least partially within the through-holes 108. A shaft portion of the end caps 138 can snap into the through-holes 108 and/or threadably engage the end portions 122 of the elongate support 120 therein. A head portion of each end cap 138 is tombstone shaped, i.e. includes a flat edge and rounded perimeter. In other instances, the head portion of each end cap 138 can be circular. In certain instances, the end caps 138 can be comprised of silicone. Upon completing the assembly, the piece of furniture 180 (FIG. 2) can be leveled in the desired location by adjusting leg levelers at the foot or base of each leg 106, for example.

In various instances, the horizontal frame member 104 can include additional through-holes 108 for receiving additional elongate supports 120. The quantity of elongate supports 120 and the corresponding quantity of through-holes 108 can depend on the dimensions of the horizontal frame member 104 and the depth of the table top 140, for example.

In certain instances, the trestle assembly 102 can be an integrally-formed component. In other instances, the legs 106 can be releasably attached to the horizontal frame member 104.

In various instances, the trestle assembly 102 can have less than two legs. For example, the trestle assembly 102 can have a single column leg. In other instances, the trestle assembly 102 can include three or more legs.

In certain instances, the table top 140 can include less than two table top clamps 142. For example, the table top 140 can include a single table top clamp 142 for locking the elongate support 120 to the table top 140. In other instances, the table top 140 can include more than two table top clamps 142. The quantity of clamps 142 along the underside of the table top 140 can depend on the span of the elongate support 120, the length of the table top 140, and the distance between the trestle assemblies 102, for example.

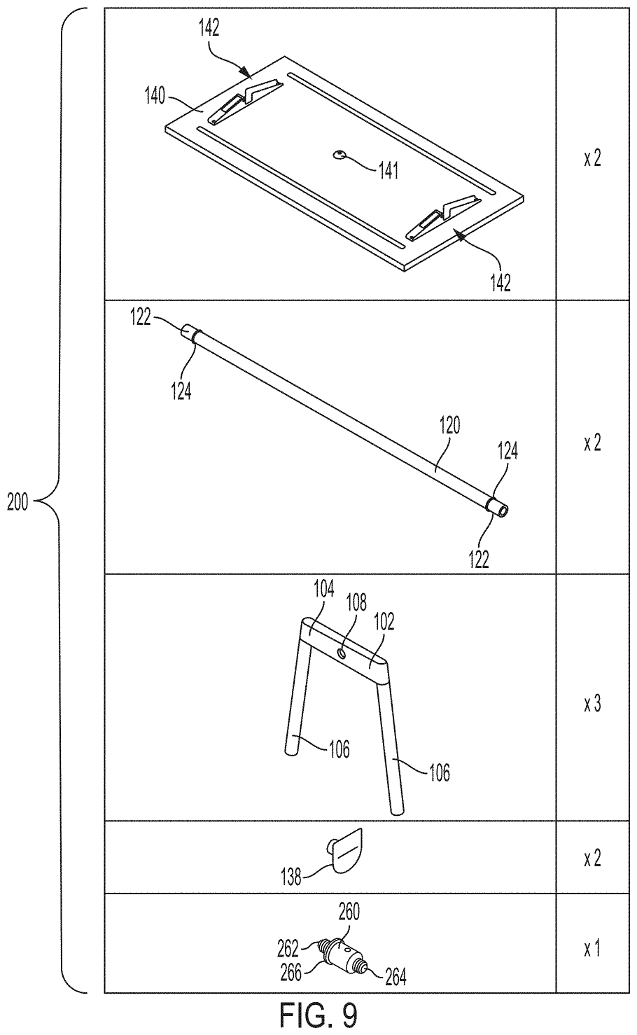

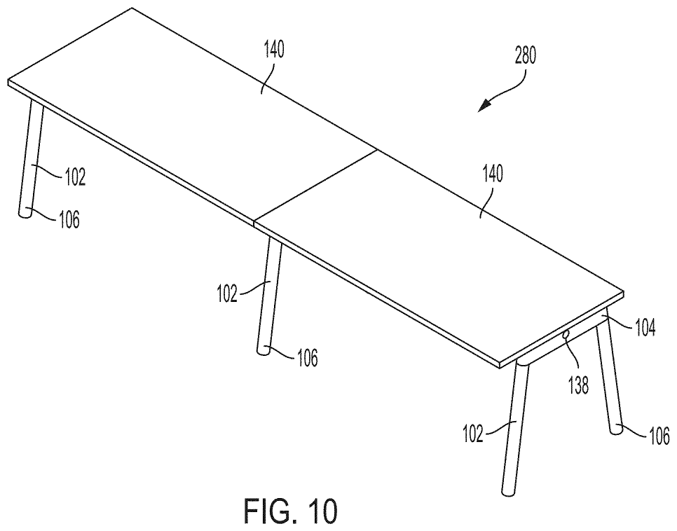

In various instances, the components of the kit 100 in FIG. 1 can be supplemented with additional components, i.e. add-on components, to build different configurations and/or a larger piece of furniture. For example, one or more additional trestle assemblies 102, elongate supports 120, and/or table tops 140 can be added to the kit 100 to expand the piece of furniture 180. Referring now to FIGS. 9 and 10, an expanded kit 200 (FIG. 9) for building a piece of furniture 280 (FIG. 10) is depicted. The expanded kit 200 includes three trestle assemblies 102, two elongate supports 120, two end caps 138, and two table tops 140. The expanded kit 200 also includes a connector 260 having threaded connections 262, 264 on either end. Each threaded connection 262, 264 can threadably engage one of the elongate supports 120 to connect them end-to-end. Connecting the elongate supports 120 end-to-end is further described herein.

In other instances, an add-on kit can be provided. An add-on kit can include the components of the expanded kit 200 excluding the components of the kit 100. Specifically, such an add-on kit can include one trestle assembly 102, one elongate support 120, one table top 140, and one connector 260. Such an add-on kit can be utilized to expand the piece of furniture 180 into the piece of furniture 280, for example.

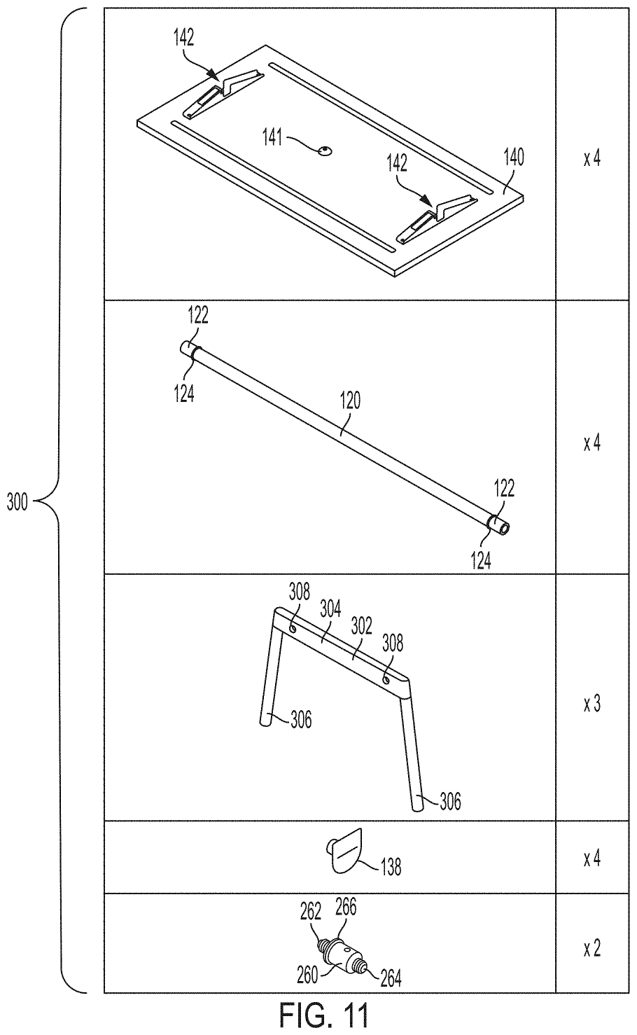

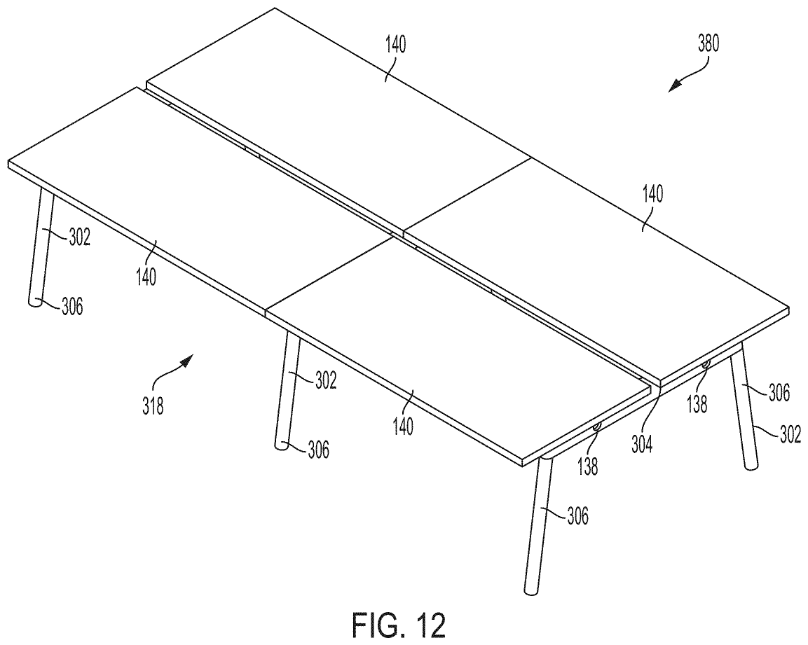

Referring now to FIGS. 11 and 12, a kit 300 for assembling a piece of furniture 380 is shown. The piece of furniture 380 can be used as a desk or table. The kit 300 includes three trestle assemblies 302, four elongate supports 120, four end caps 138, four table tops 140, and two connectors 260. As further described herein, the kit 300 can be expanded to include additional and/or duplicative components to facilitate expansion of the piece of furniture 380. For example, a desk or table can be expanded to accommodate additional people.

The trestle assemblies 302 are similar to the trestle assemblies 102 (FIGS. 1 and 2) in many aspects. The trestle assemblies 302 each include a horizontal frame member 304 extending between two opposing legs 306. A leg 306 can extend from each end of the horizontal frame member 304, for example. When the piece of furniture 380 is assembled, the horizontal frame member 304 can be positioned horizontally. The legs 306 can be positioned vertically or obliquely-oriented relative to the horizontal frame member 304, which can span the space between the two legs 306. The horizontal frame member 304 includes two apertures or through-holes 308, and each through-hole 308 is dimensioned to receive an end portion 122 of the elongate support 120. The through-holes 108 are equidistantly-spaced laterally outboard from the center of the horizontal frame member 104 and equidistantly-spaced laterally inboard from each leg 306. Stated differently, the trestle assembly 302 is symmetrical about a central, vertical axis through the horizontal frame member 304 and equidistant from each leg 306.

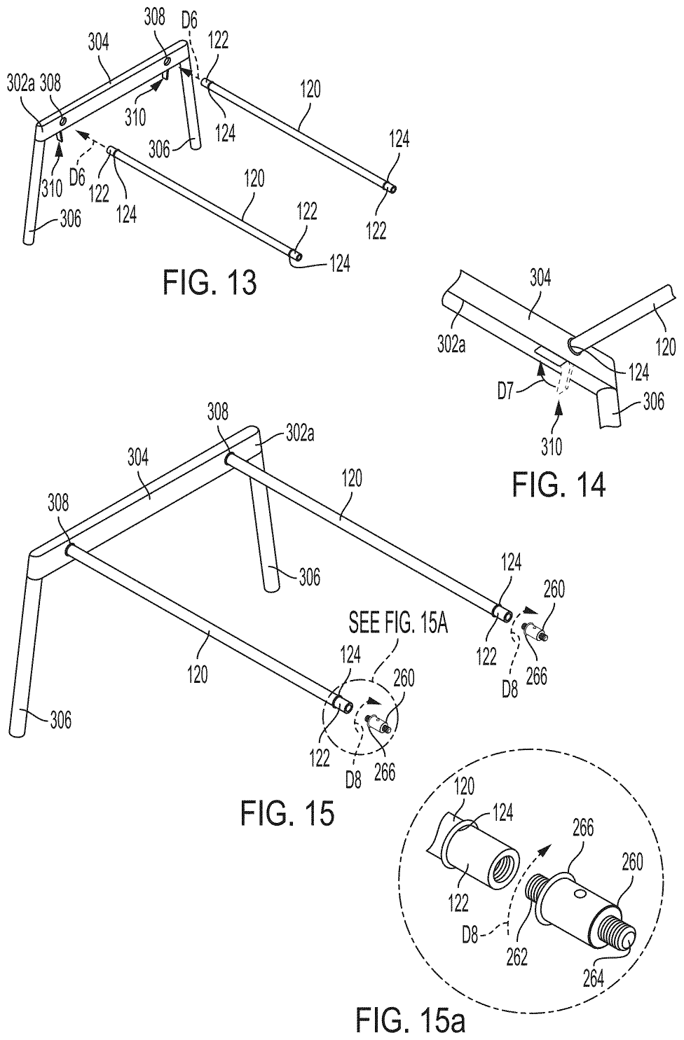

To assemble the piece of furniture 380, the trestle assemblies 302 are connected to the elongate supports 120. Referring to FIG. 13, to connect the elongate supports 120 to the trestle assembly 302, the end portions 122 of the elongate supports 120 can be moved in the direction D6 and seated in the through-holes 308 in a first trestle assembly 302a and a trestle clamp 310 can be actuated (FIG. 14) by pivoting a lever thereof in the direction D7 to securely clamp or lock each elongate support 120 to the first trestle assembly 302a. The elongate supports 120 are fully seated in the first trestle assembly 302a when the ridge 124 of each elongate support 120 is pressed against, i.e., in abutting contact with, the horizontal frame member 304.

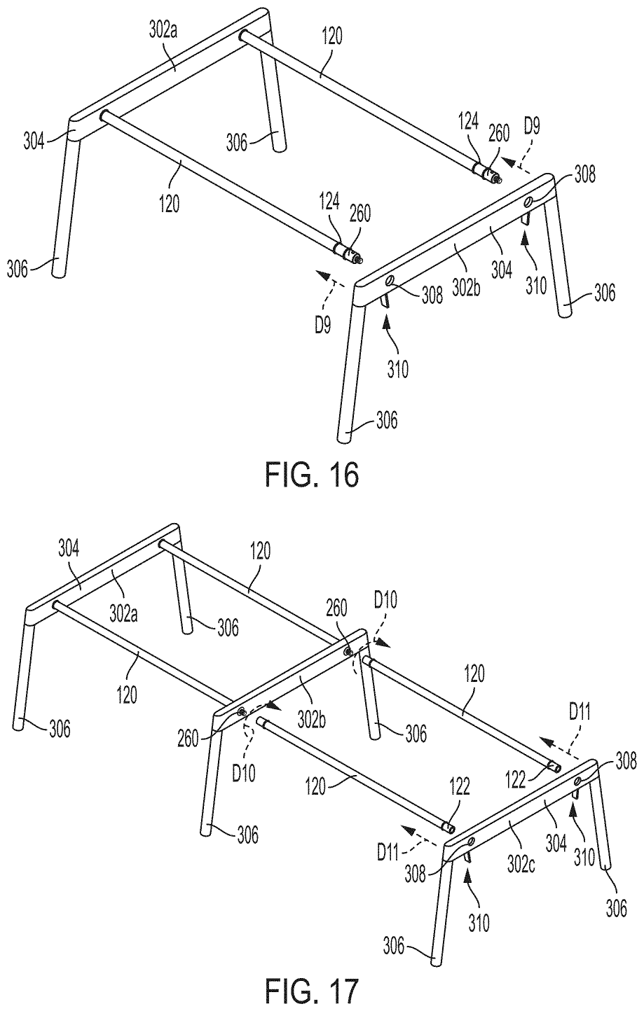

Referring to FIGS. 15 and 15A, a connector 260 can be coupled to an end portion 122 of each elongate support 120. For example, the connectors 260 can include a first threaded end 262 and a second threaded end 264. A ridge 266 can extend around, or at least partially around, the connector 260 adjacent to the first threaded end 262. The threaded ends 262, 264 can threadably engage elongate supports 120 to connect two elongate supports 120 end-to-end. For example, the first threaded end 262 can be externally threaded and can be threadably connected to an internally-threaded aperture of one of the elongate supports 120 by rotating the connector 260 in the direction D8 such that the ridge 266 is on the side of the first trestle assembly 302a. Referring now to FIG. 16, before connecting the elongate supports 120 end-to-end, the connectors 260 can be seated in the through-holes 308 in a second trestle assembly 302b by moving the second trestle assembly 302b in the direction D9 such that the ridges 266 are pressed against, i.e., in abutting contact with, the horizontal frame member 304 of the second trestle assembly 302b. A central body portion of the connector 260 is positioned within the through-hole 308 and the second threaded end 264 of the connector 260 extends out of the through-hole 308 away from the second trestle assembly 302b. Referring still to FIG. 16, trestle clamps 310 on the second trestle assembly 302b can be actuated to securely clamp or lock the connectors 260, i.e. the central body portion thereof positioned in each through-hole 308, to the second trestle assembly 302b.

Referring primarily now to FIG. 17, the second pair of elongate supports 120 are rotated in the direction D10 and threadably connected to the connectors 260 clamped to the second trestle assembly 302b. For example, the second threaded ends 264 can be externally threaded and can be threadably connected to an internally-threaded aperture of one of the elongate supports 120 by rotating the elongate supports 120 in the direction D10. The directions D8 and D10 are the same rotational direction and attaching the second pair of elongate supports 120 does not loosen and/or detach the threaded connection between the first pair of elongate supports 120 and the connectors 260. Additionally, the through-holes 308 in a third trestle assembly 302c are aligned with the end portions 122 of the elongate supports 120 and the third trestle assembly 302c is moved in the direction D11 such that the end portions 122 are seated in the through-holes 308. A trestle clamp 310 can be actuated to securely clamp or lock each elongate support 120 to the third trestle assembly 302c.

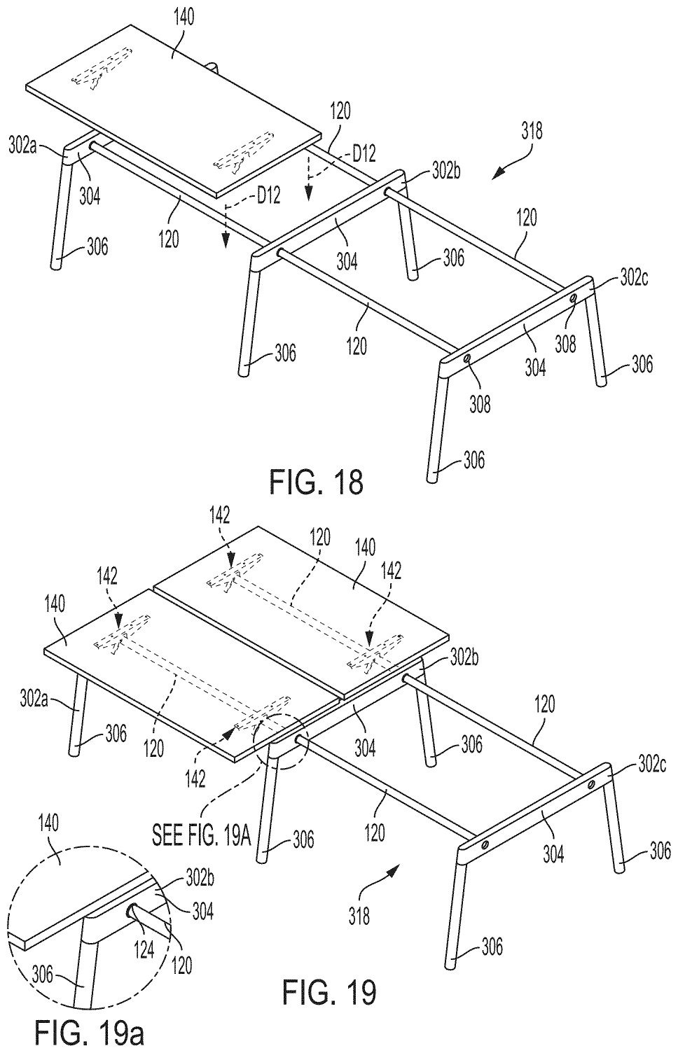

Referring now to FIG. 18, the connected trestle assemblies 302a, 302b, 302c and the four elongate supports 120 can form a sawhorse portion 318 of the piece of furniture 380 (FIG. 12). The table tops 140 can then be secured to the sawhorse portion 318. The table tops 140 include two table top clamps 142 for locking the elongate supports 120 to the table tops 140. For example, each of the table tops 140 can be positioned over the sawhorse portion 318 such that one of the elongate supports 120 is aligned with the table top clamps 142 of the table top 140. The table tops 140 can then be moved in the direction D12 to lower the table top 140 onto the elongate support 120. Each table top 140 can be centered over one of the elongate supports 120 and centered between the supporting trestle assemblies 302. Referring to FIGS. 19 and 19A, the table tops 140 can be arranged so they share the center or second trestle assembly 302b equally. In such instances, the table tops 140 are symmetric relative to the horizontal frame member 304 of the center or second trestle assembly 302b. After the table tops 140 are appropriately positioned on the elongate supports 120 (FIG. 18), the table top clamps 142 can be actuated in direction D14 (FIG. 21) to secure the table tops 140 to the elongate supports 120.

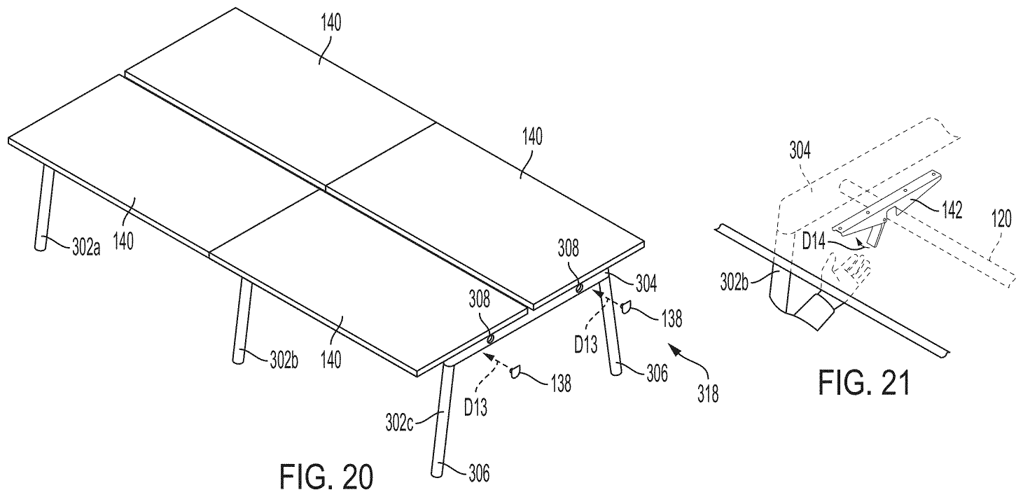

Referring primarily to FIG. 20, end caps 138 can be moved in the direction D13 relative to the third trestle assembly 302c to be positioned in the through-holes 308 to close or seal the through-holes 308 and provide a clean, smooth, and aesthetically-pleasing appearance. The end caps 138 can snap into the through-holes 308 and/or threadably engage the end portions 122 of the elongate support 120 therein. Upon completing the assembly, the piece of furniture 380 (FIG. 12) can be leveled in the desired location by adjusting leg levelers at the foot or base of each leg 306, for example.

In various instances, the horizontal frame member 304 can include additional through-holes 308 for receiving additional elongate supports 120. The quantity of elongate supports 120 and the corresponding quantity of through-holes 308 can depend on the dimensions of the horizontal frame member 304 and the depth of the table top 140.

In certain instances, the trestle assembly 302 can be an integrally-formed component. In other instances, the legs 306 can be releasably attached to the horizontal frame member 304. In such instances, the legs 306 may be interchangeable with the legs 106 and/or other table legs, for example.

In various instances, the trestle assembly 302 can have less than two legs. For example, the trestle assembly 302 can have a single column leg. In other instances, the trestle assembly 302 can include three or more legs.

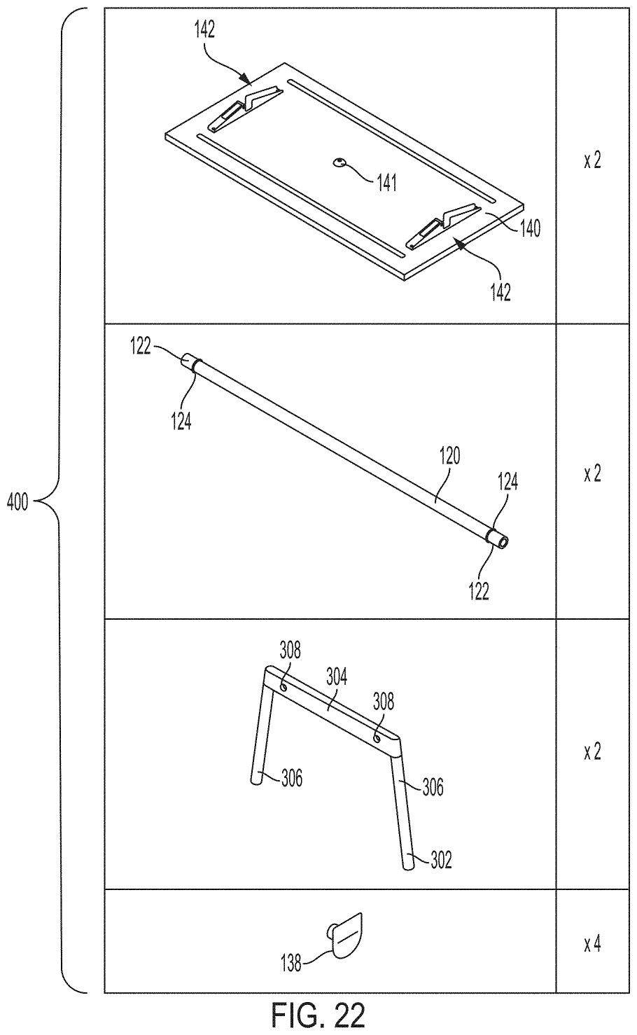

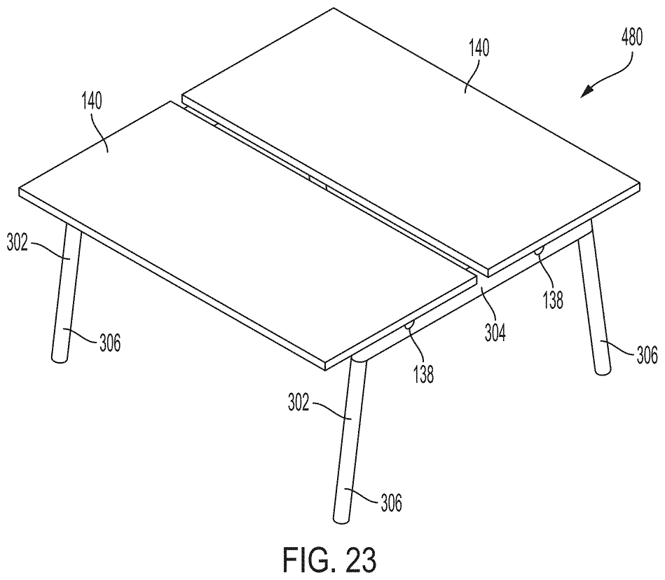

In various instances, the components of the kit 300 in FIG. 11 can be supplemented with additional components, i.e. add-ons, to build a different and/or larger piece of furniture. In other instances, alternative kits can be provided to build smaller and/or different configurations. For example, referring to FIGS. 22 and 23, another kit 400 (FIG. 22) for building a piece of furniture 480 (FIG. 23) is depicted. The kit 400 includes two trestle assemblies 302, two elongate supports 120, four end caps 138, and two table tops 140.

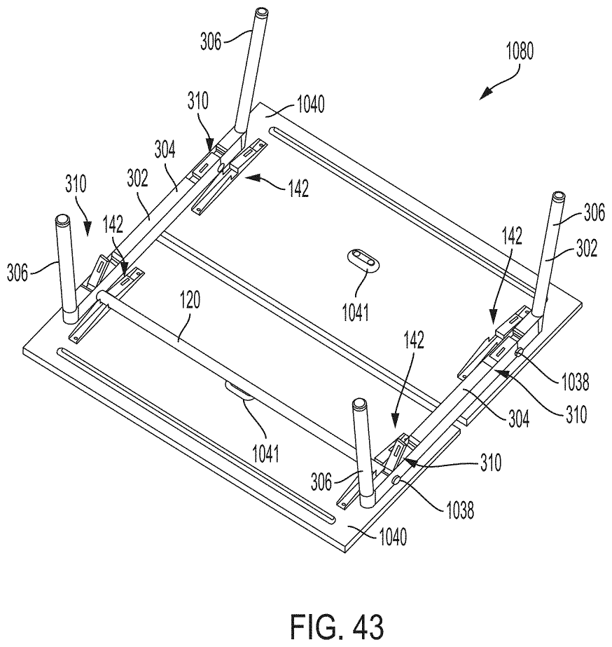

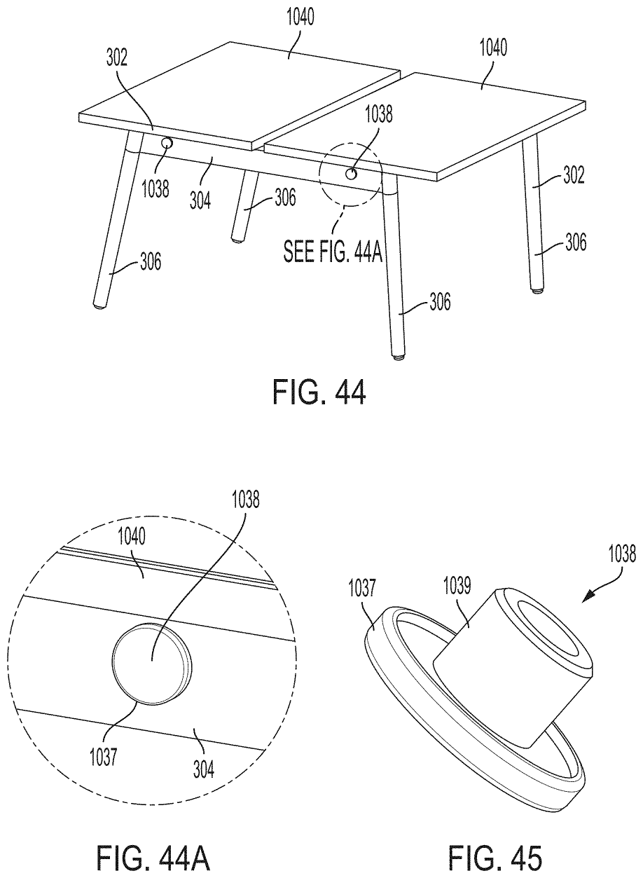

A piece of furniture 1080 is shown in FIGS. 43 and 44. The piece of furniture 1080 is similar to the piece of furniture 480 in many aspects. However, alternative table tops 1040 replace the table tops 140 and alternative end caps 1038 replace the end caps 138 in the piece of furniture 1080.

The table top 1040 is similar to the table top 140 and includes table top clamps 142; however, instead of the touchdown bumper 141, a touchdown bumper 1041 (FIG. 43) is positioned on the underside of the table top 1040. The elongate support 120 can support the table top 1040 at the touchdown bumper 1041 along the length of the elongate support 120 intermediate the table top clamps 142, e.g. halfway between the ends of the elongate support 120. The touchdown bumpers 1041 are pill-shaped. A pair of apertures extend through the bumpers 1041 for receiving fasteners to secure the bumpers 1041 to the underside of the table top 140. The bumpers 1041 also include an elongate trough having a curvature configured to match the curvature of the elongate support 120 such that the elongate support 120 is cradled in the elongate trough of the bumper 1041.

Referring primarily to FIGS. 44A and 45, the end caps 1038 are similar to the end caps 138 and include a cylindrical shaft portion 1039; however, the end caps 1038 include a circular head portion 1037. The shaft portion 1039 can extend into the through-holes 308 in the trestle assemblies 302 and the head portion 1037 can provide a clean, smooth, and aesthetically-pleasing appearance. The end caps 1038 can be comprised of silicone, for example.

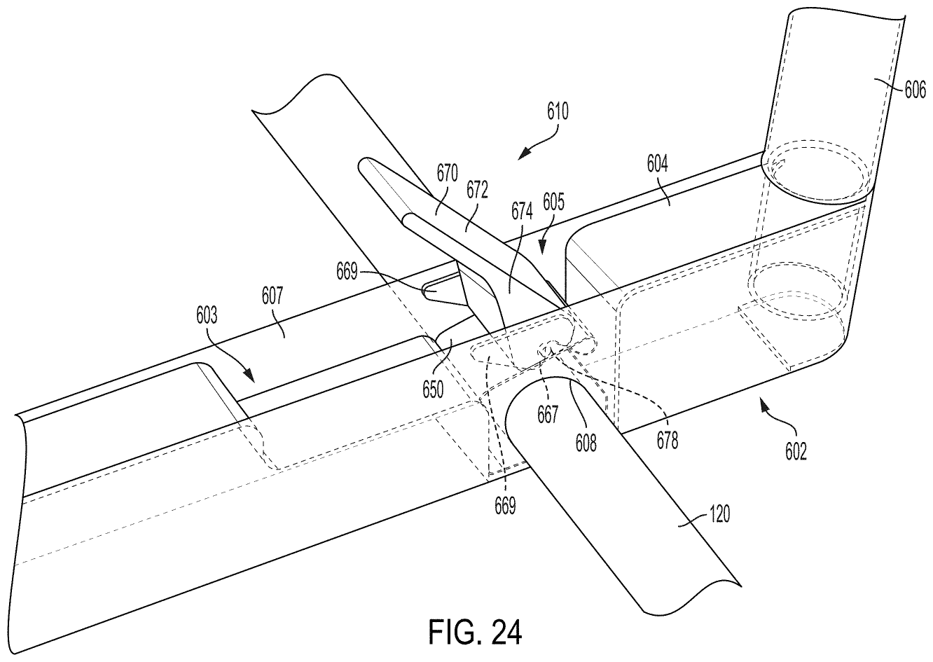

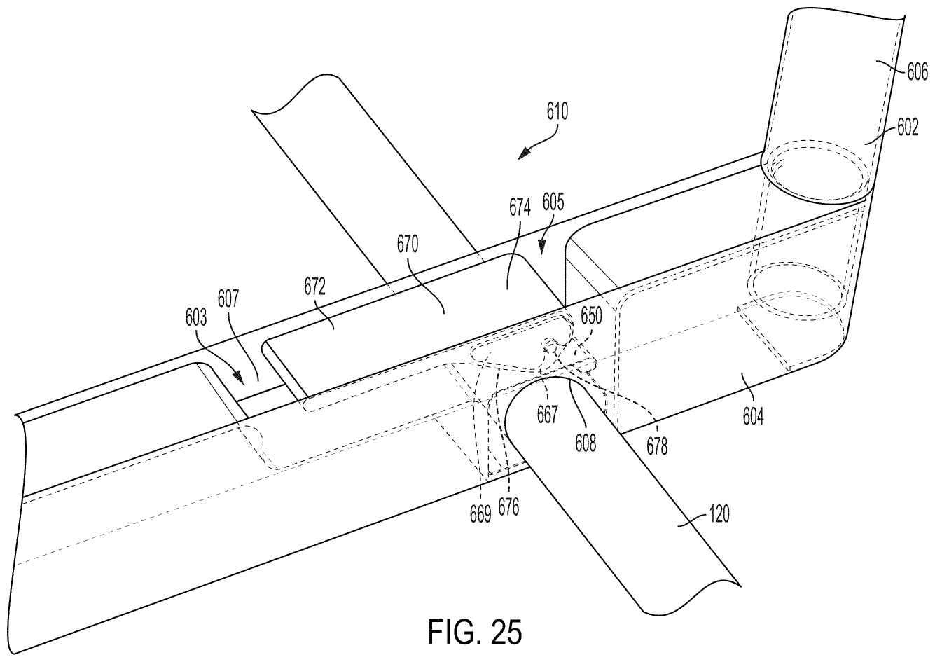

A trestle clamp arrangement 610 is shown in FIGS. 24 and 25. The trestle clamp arrangement 610 is incorporated into a trestle assembly 602, which is similar to the trestle assembly 102 (FIGS. 1-10) and the trestle assembly 302 (FIGS. 11-23) in many aspects. For example, the trestle assembly 602 includes a horizontal frame member 604 extending between two opposing legs 606. The horizontal frame member 604 includes at least one through-hole 608 that is dimensioned and configured to receive an elongate support, such as the elongate support 120, for example. As further described herein, the trestle clamp arrangement 610 is incorporated into the horizontal frame member 604 and is positioned to engage the elongate support 120 positioned in the through-hole 608.

The trestle clamp arrangement 610 includes a locking spring 650 and a locking lever 670. Moreover, the trestle clamp arrangement 610 is movable between an unlocked configuration (FIG. 24) and a locked configuration (FIG. 25). For example, the locking lever 670 can pivot between a first orientation (FIG. 24) and a second orientation (FIG. 25) to move the locking spring 650 between a first shape (FIG. 24) and a second shape (FIG. 25). The first shape can correspond to a neutral and/or non-deflected shape, for example, and the second shape can correspond to a spring-loaded, deflected and/or deformed shape, for example. In other instances, the first shape can correspond to a less-deflected shape than the second shape. Rotation of the locking lever 670 from the first orientation to the second orientation is configured to deform the locking spring 650 from the first shape to the second shape. The spring force generated by the locking spring 650 in the second shape is configured to clamp or lock the elongate support 120 within the through-hole 608.

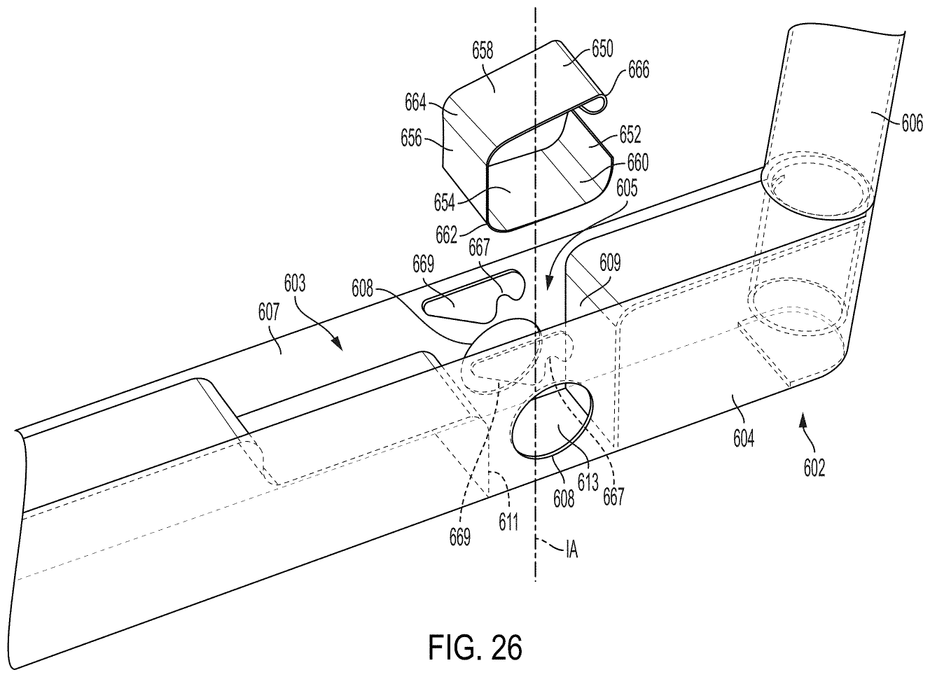

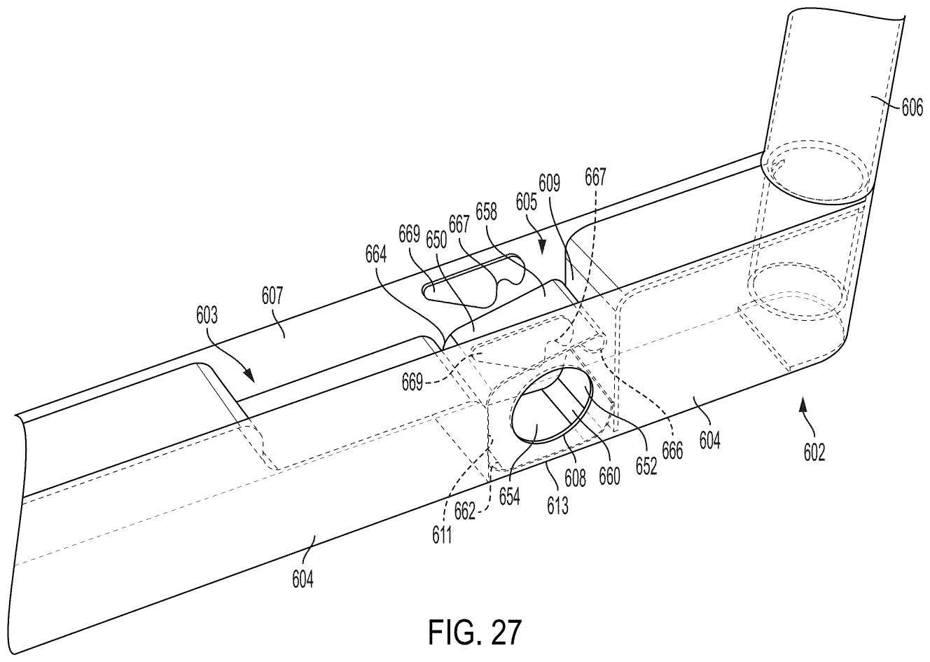

Portions of the trestle clamp arrangement 610 are shown in FIGS. 26 and 27. The locking spring 650 is depicted in an exploded position relative to the horizontal frame member 604 in FIG. 26 for clarity. Referring primarily to FIG. 26, the horizontal frame member 604 includes a cavity, or spring receptacle, 605 defined between a first cavity-facing surface 609, a second cavity-facing surface 611 opposing and facing the first cavity-facing surface 609, a pair of opposing sidewall surfaces 607 extending between the first cavity-facing surface 609 and the second cavity-facing surface 611, and a bottom surface 613 extending between the first cavity-facing surface 609, the second cavity-facing surface 611, and the opposing sidewall surfaces 607. As a result, the cavity 605 defines a rectangular, or generally-rectangular, prismatic three-dimensional geometry within the horizontal frame member 604. The cavity 605 is bounded on five of its six sides. For example, only a top side of the cavity 605 is open to receive the locking spring 650. The through-hole 608 is aligned with the cavity 605 and extends through the opposing sidewall surfaces 607. When assembled, the locking spring 650 is dimensioned to fit snuggly within the cavity 605. The clearance between the locking spring 650 and the cavity walls, i.e., the first cavity-facing surface 609, the second cavity-facing surface 611, the pair of opposing sidewall surfaces 607, and the bottom surface 613 of the cavity 605 can be minimized to allow smooth entry of the locking spring 650 into the cavity 605 while reducing relative movement between the cavity 605 and the installed locking spring 650.

The locking spring 650 comprises a folded flat sheet of material generally forming a C-shaped channel. The sheet of material is metallic in various instances. For example, the sheet forming the locking spring 650 is a folded steel spring in certain instances.

In certain instances, the locking spring 650 comprises a folded leaf spring comprising a plurality of obliquely-oriented planar or flat portions. For example, the locking spring 650 can include planar portions between rounded corners. More specifically, the locking spring 650 includes a first portion 652, a second portion 654, a third portion 656, a spring arm 658, a first corner 660 between the first portion 652 and the second portion 654, a second corner 662 between the second portion 654 and the third portion 656, and a third corner 664 between the third portion 656 and the spring arm 658. The first portion 652, the second portion 654, and the third portion 656 are structured to face and abut surfaces defining the cavity 605 in the horizontal frame member 604 when the lock spring 650 is positioned in the cavity 605. Specifically, the first portion 652, the second portion 654, and the third portion 656 are adjacent to the first cavity-facing surface 609, the bottom surface 613, and the second cavity-facing surface 611, respectively, when the locking spring 650 is positioned in the cavity 605.

The first portion 652, the second portion 654, and the third portion 656 define flat surfaces to match the surfaces 609, 611, and 613. In other instances, the first portion 652, the second portion 654, and/or the third portion 656 can define a contour to match and/or correspond to a contoured surface of the cavity 605. The first corner 660, the second corner 662, and the third corner 664 define rounded corners. At least one of the corners 660, 662, and 664 is configured to further bend and/or deflect when a load is applied to the locking spring 650.

The spring arm 658 is configured to deflect when a load is applied to the locking spring 650. For example, when the locking spring 650 is retained in the cavity 605, the locking spring 650 can bend at the third corner 664 such that the spring arm 658 is deflected downward into the cavity 605 toward the first portion 652 and the second portion 654. The spring arm 658 terminates at a hooked end 666, which is deflectable toward the first portion 652 when a load is applied to the locking spring 650. The distance between the hooked end 666 and the first portion 652 can control or limit the deflection of the spring arm 658 when a load is applied to the locking spring 650.

Referring primarily to FIG. 26, the locking spring 650 is movable along an installation axis IA to install the locking spring 650 in the cavity 605. Referring now to FIG. 27, the locking spring 650 is fully seated in the cavity 605 such that a minimal clearance is provided between the locking spring 650 and the cavity 605. For example, the second portion 654 of the locking spring 650 is positioned against, i.e. abutting, the bottom surface 613 of the cavity 605. Moreover, a clearance between the locking spring 650 and the cavity-facing walls 609, 611 can be minimized to permit a smooth insertion of the locking spring 650 into the cavity 605 while minimizing relative movement of the locking spring 650 within the cavity 605.

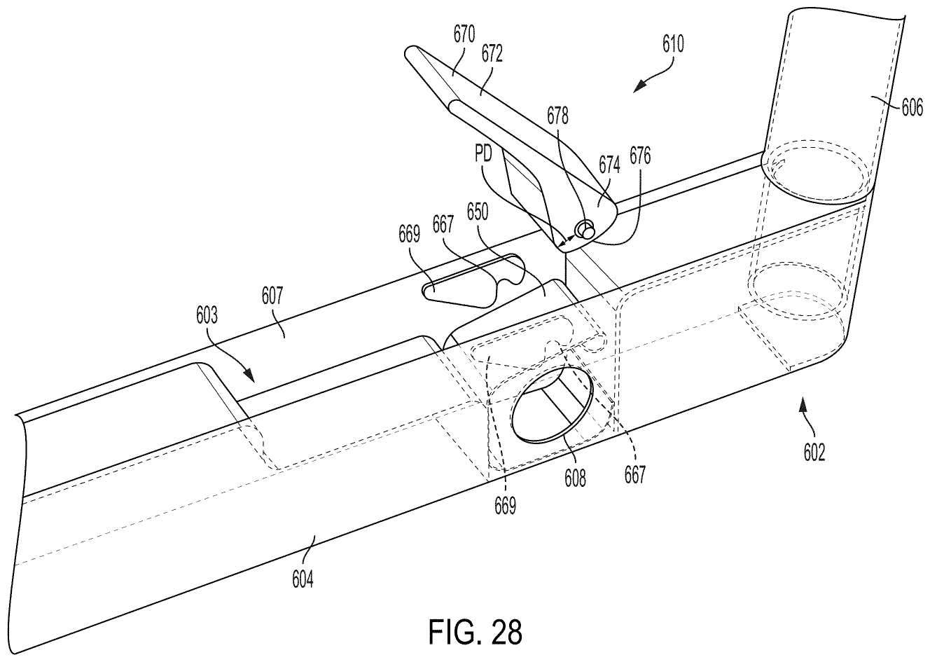

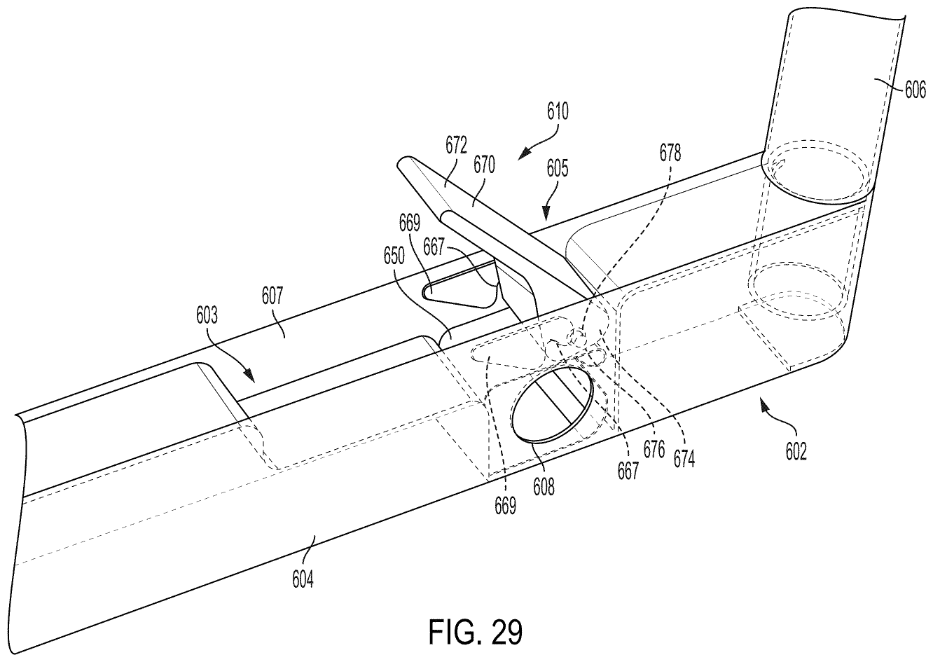

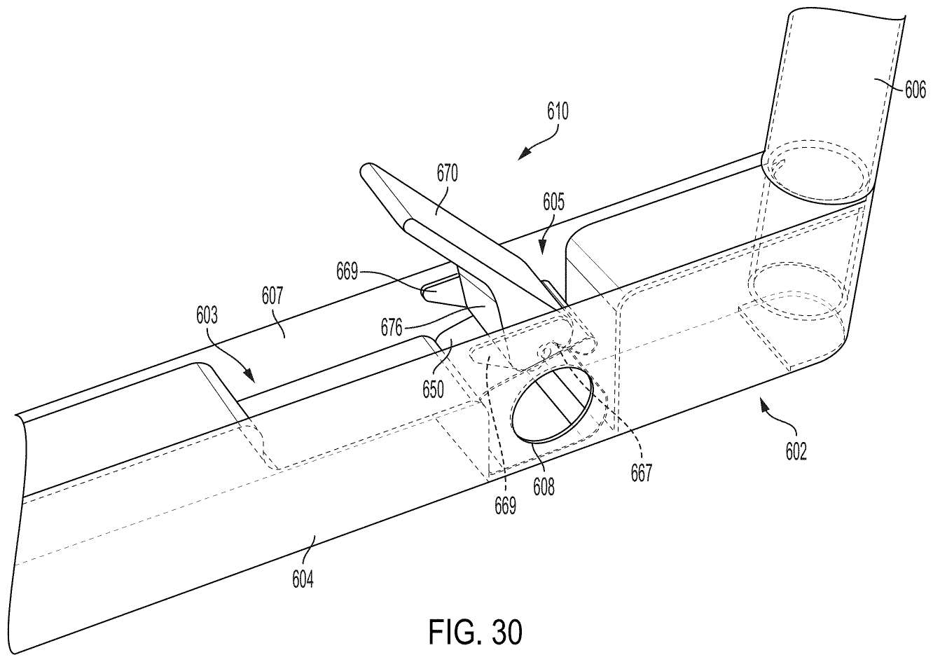

Portions of the trestle clamp arrangement 610 are also shown in FIGS. 28-30. The locking lever 670 is depicted in an exploded position relative to the horizontal frame member 604 in FIG. 28 for clarity, in an assembled position in FIG. 30, and in an intermediate, partially-assembled position in FIG. 29. Referring primarily to FIG. 28, the locking lever 670 includes a lever arm 672, a fulcrum 674 having a camming surface 676, and a pin 678 extending laterally through the fulcrum 674 and extending laterally outward from the fulcrum 674. The pin 678 is press-fit in the fulcrum 674. In various instances, a single pin 678 can extend through the fulcrum 674 and opposing ends of the pin 678 can extend laterally outward from the fulcrum 674. In other instances, a pair of pins can be press fit, or at least partially embedded, in the fulcrum 674. The fulcrum 674 is eccentric with respect to the pin 678. In other words, the orthogonal distance between the camming surface 676 and the axis of rotation defined by the pin 678 varies and includes a peak distance PD, as further described herein.

The locking lever 670 is retained by pin receptacles 669 mounted to the opposing sidewall surfaces 607 of the horizontal frame member 604 within the cavity 605. For example, each pin receptacle 669 can be a plate that is mounted to the opposing sidewall surfaces 607. Each plate can include a hooked perimeter portion 667 that is configured to engage and hold the pin 678 when the locking lever 670 is installed in the cavity 605. The plates can be welded, screwed, or otherwise fastened to the horizontal frame member 604, for example

Referring to FIG. 29, the locking lever 670 is in an intermediate position and moving toward an assembled position. Specifically, the locking lever 670 and the pin 678 thereof are configured to fit into the cavity 605 around the pin receptacle 669. As the locking lever 670 moves downward into the cavity 605, the locking lever 670 is configured to compress the locking spring 650. For example, the spring arm 658 of the locking spring 650 thereof is deflected downward toward the first portion 652 and the second portion 654 of the locking spring 650 in FIG. 29. As each end of the pin 678 maneuvers into the hooked perimeter portion 667 of the pin receptacle 669, the locking spring 650 can bias the locking lever 670 upward to hold the ends of the pin 678 in place within the hooked perimeter portions 667 of the pin receptacles 669.

The locking lever 670 can define a one-piece body, which is integrally formed or molded as a single component. In certain instances, the pin 678 can be press fit in an aperture in the locking lever 670. In other instances, the locking lever 670 can be molded over the pin 678. In certain instances, the locking lever 670 can be made of a polymeric material. For example, the locking lever 670 can be made of one or more synthetic polymers and can be melt-processed. In certain instances, the locking lever 670 can be molded with nylon. A molded locking lever can include one or more cored-out cavities to reduce material costs, such as a series of small cavities along the lateral sides of the lever arm 672, for example. In other instances, the locking lever 670 can be made of a metallic material. For example, the locking lever 670 can be made of aluminum. An aluminum locking lever can also include one or more cavities to reduce material costs, such as a large cavity in the fulcrum 674, for example.

In various instances, the locking lever 670 and the cavity 605 can be symbiotically designed such that the dimensions of the locking lever 670 are configured to cover a significant portion of the cavity 605 when the locking lever 670 is in the second orientation. For example, the width of the locking lever 670 can correspond to the space between the opposing sidewalls 607, such that the locking lever 670 fits snuggly or closely between the opposing sidewalls 607. Additionally or alternatively, the cavity 605 can include an extension or notch 603 that is dimensioned to receive the locking lever 670. In such instances, the locking lever 670 can act as a shield, cover, or protective barrier, which can keep debris from entering the cavity 605 and interfering with the operation of the trestle clamp arrangement 610. For example, referring again to FIG. 25, the lever arm 672 is nestled between and recessed relative to the opposing sidewalls 607 within the cavity 605, i.e., below the edge of each sidewall 607. In such instances, the lever arm 672 can also be protected from accidental and/or unintentional actuations, for example. In various instances, the clearance between the lever arm 672 and the surfaces of the horizontal frame member 604, e.g. the opposing sidewall surfaces 607, can be minimized.

Referring again to FIGS. 24 and 25, as the lever arm 672 is rotated and the locking lever 670 moves from the first orientation (FIG. 24) to the second orientation (FIG. 25), the fulcrum 674 rotates about the axis defined by the pin 678 and the camming surface 676 moves along the spring arm 658. In the second orientation, the camming surface 676 has compressed the spring arm 658 downward such that the locking spring 650 is in the second shape. In various instances, in the second shape (FIG. 25), the first, second, and third portions 652, 654, 656 of the locking spring 650 can be pressed against the adjacent surfaces of the cavity 605.

Owing to the eccentricity of the camming surface 676 relative to the pin 678, the locking lever 670 is clamped in the second orientation. For example, the camming surface 676 can define the peak distance PD (FIG. 28) from the axis of rotation A defined by the pin 678 and the locking lever 670 can move the camming surface 676 through the peak distance PD to a lesser distance as the locking lever 670 moves between the first orientation (FIG. 24) and the second orientation (FIG. 25). Moving through the peak distance PD, e.g. over-center, can require an increased force to further compress the locking spring 650. Upon moving through the peak distance PD, the locking lever 670 can remain clamped, or locked, in the second orientation until an increased force is again applied to move the locking lever 670 back through the peak distance PD back to the first orientation.

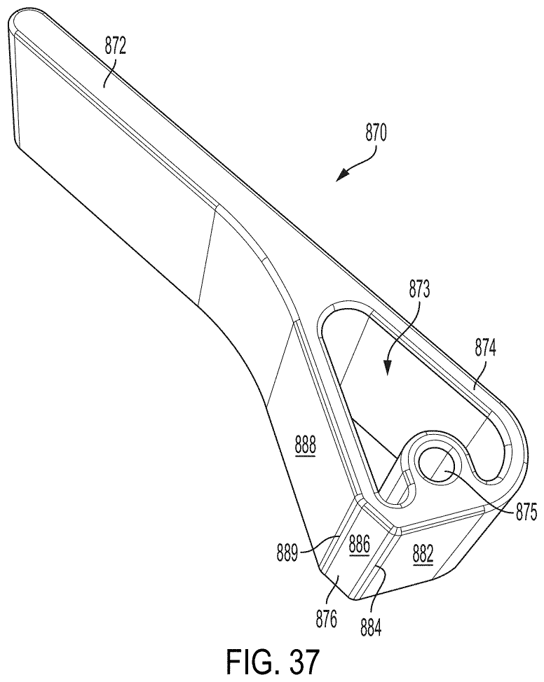

When the locking lever 670 is in the second orientation, i.e. clamped, the locking spring 650 can impart a spring back force onto the camming surface 676. However, owing to the eccentric orientation of the fulcrum 674 relative to the axis of rotation A, the locking spring 650 resists further rotation of the locking lever 670 effectively locking the locking lever 670 in place. In such instances, the locking lever 670 and the locking spring 650 can be self-locking when the locking lever 670 is in the second orientation because any rotation of the locking lever 670 away from the second orientation is resisted by the locking spring 650. Eccentric camming surfaces of a locking lever are further described herein with reference to FIGS. 37-42, for example.

When the elongate support 120 extends through the through-hole 608 and the locking spring 650, the locking lever 670 compresses the locking spring 650 to clamp the locking spring around the elongate support 120. More specifically, the locking spring 650 directly clamps at least partially around a longitudinal portion of the elongate support 120, which has an arcuate profile. As a result, the elongate support 120 is clamped to the horizontal frame member 604 of the trestle assembly 602 by the locking spring 650, which is retained in the horizontal frame member 604.

The trestle clamp arrangement 610 can be incorporated into the trestle assemblies 102 and/or 302, for example. Moreover, the trestle clamp arrangement 610 can be configured to securely clamp or lock an elongate member, such as the elongate supports 120 and/or the connectors 260, to a horizontal frame member to assemble a piece of furniture, such as the pieces of furniture 180, 280, 380, and 480, for example.

The trestle clamp arrangement 610 can provide a robust and secure clamp throughout multiple cycles of clamping and unclamping. For example, the single moving component—the locking lever 670—positioned to directly contact, engage and actuate the clamping element—the locking spring 650—minimizes the moving components and interactions thereof to securely clamp and unclamp (or release) the elongate support 120 to the horizontal frame member 604.

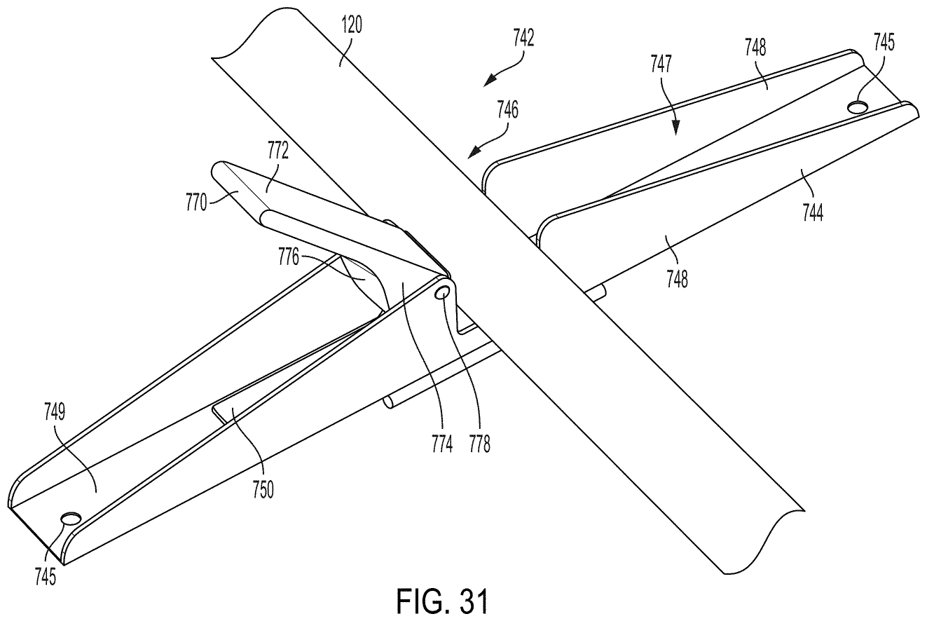

A table top clamp arrangement 742 is shown in FIGS. 31-36. The table top clamp arrangement 742 is incorporated into the table top 140 (FIGS. 1-23) in certain instances. In such instances, the table top clamp arrangement 742 is mounted to the underside of the table top 140 and positioned to engage the elongate supports 120 of a trestle assembly, i.e. the trestle assembly 102 and/or the trestle assembly 302, for example.

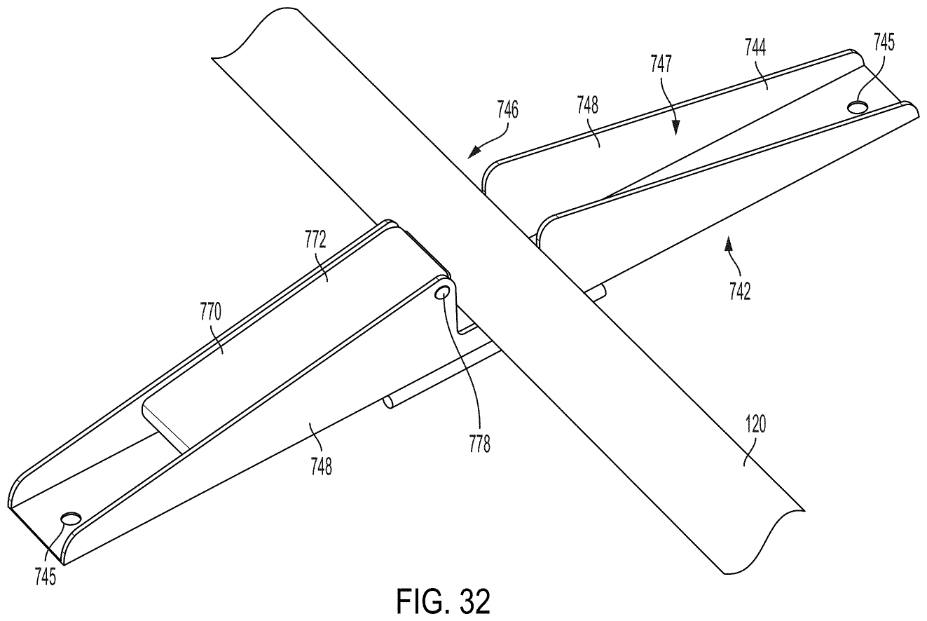

The table top clamp arrangement 742 includes a bracket, or yoke, 744, a locking spring 750, and a locking lever 770. The bracket 744 includes apertures 745 dimensioned to receive fasteners, e.g. screws, for securing the bracket 744 to the underside of the table top 140. The table top clamp arrangement 742 is movable between an unlocked configuration (FIG. 31) and a locked configuration (FIG. 32). For example, the locking lever 770 can pivot between a first orientation (FIG. 31) and a second orientation (FIG. 32) to deform the locking spring 750. The clamping force generated by the locking lever 770 in the locked configuration is configured to clamp or lock the elongate support 120 to the bracket 744.

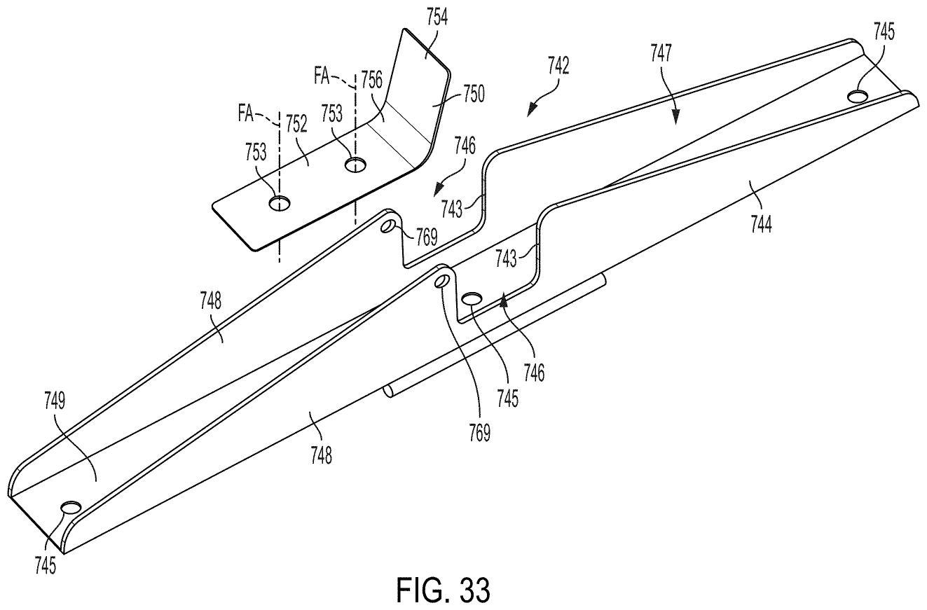

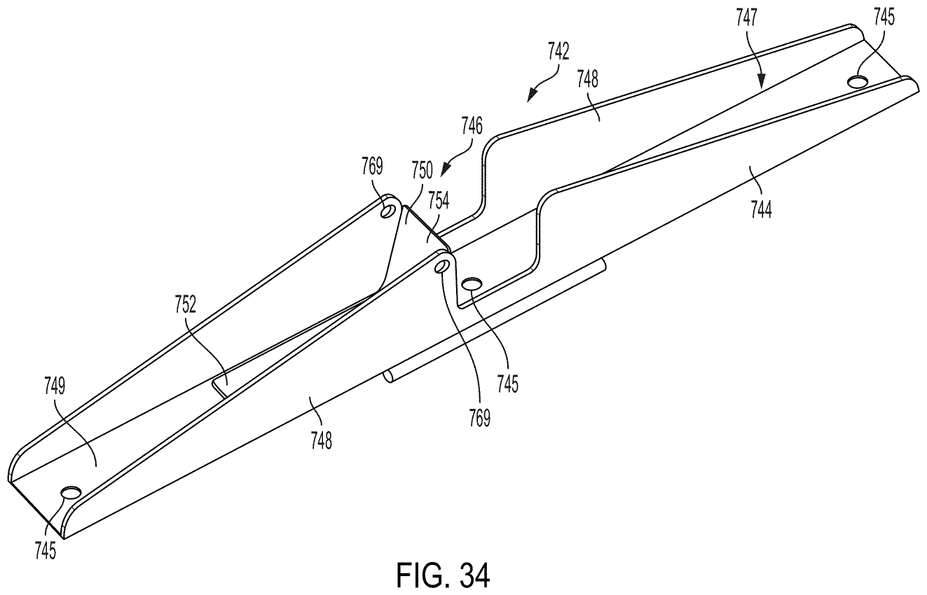

Portions of the table top clamp arrangement 742 are shown in FIGS. 33 and 34.

The locking spring 750 is depicted in an exploded view in FIG. 33 for clarity and is seated in the table top clamp arrangement 742 in FIG. 34. The bracket 744 includes sidewalls 748 extending away from a bottom surface 749. A cavity, or space 747 is defined between the sidewalls 748. When assembled, the locking spring 750 is dimensioned to fit between the sidewalls 748 and against, i.e. abutting the bottom surface 749. In other words, the locking spring 750 is positioned in the space 747. The bracket 744 also includes a cavity 746 that is dimensioned to receive the elongate support 120. The cavity 746 is a cutout or cutaway in each sidewall 748. For example, a cutout in the first sidewall 748 can be aligned with the cutout in the second sidewall 748, forming a channel through the bracket 744 perpendicular to the sidewalls 748 thereof.

The locking spring 750 comprises a folded sheet of material generally forming an L-shape. The sheet of material is metallic in various instances. For example, the sheet forming the locking spring 750 is a folded steel spring in certain instances.

The locking spring 750 can include planar portions between a rounded corner. For example, the locking spring 750 includes a first portion 752, a second portion 754, and a corner 756 between the first portion 752 and the second portion 754. The first portion 752 is structured to face and abut the bottom surface 749 when the locking spring 750 is positioned in the space 747 between the sidewalls 748. Referring primarily to FIG. 33, the first portion 752 includes apertures 753, which are dimensioned to receive fasteners, e.g. screws, for securing the locking spring 750 to the bracket 744. The screws can be installed along the fastener axes FA shown in FIG. 33. In various instances, the same fasteners that secure the bracket 744 to the underside of the table top 140 can hold the locking spring 750 thereto such that the bracket 744 is sandwiched between the locking spring 750 and the table top 140. The second portion 754 is a spring arm, which is configured to deflect when a load is applied to the locking spring 750. The second portion 754 can extend along a border or perimeter of the cavity 746 such that the elongate support 120 positioned in the cavity 746 directly engages the second portion 754.

The first portion 752 defines a flat surface that matches, i.e. is flush with, the bottom surface 749. In other instances, the first portion 752 can define a contour to match and/or correspond to a contour on the bottom surface 749. The corner 756 is a rounded corner and is configured to further bend and/or deflect when a load is applied to the second portion 754 of the locking spring 750.

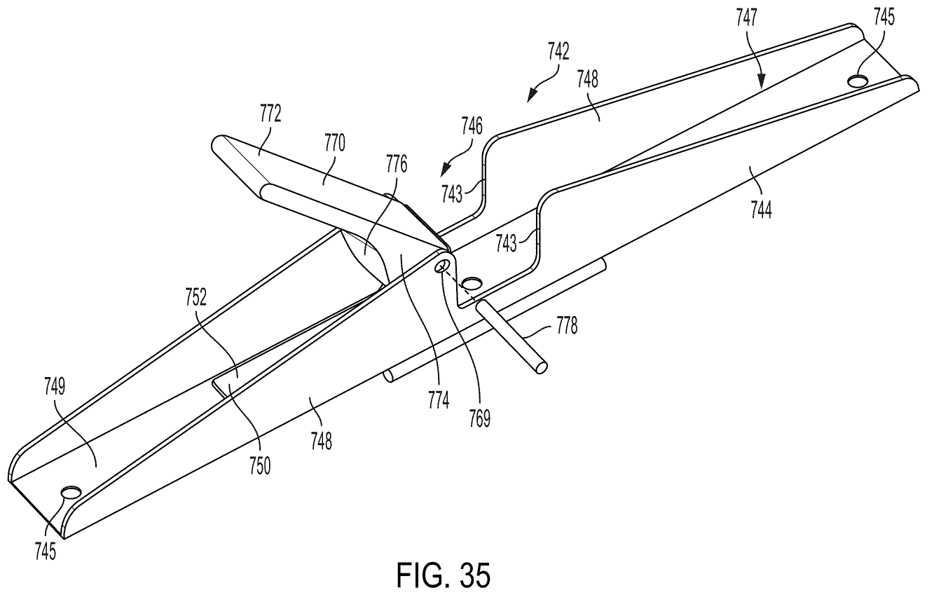

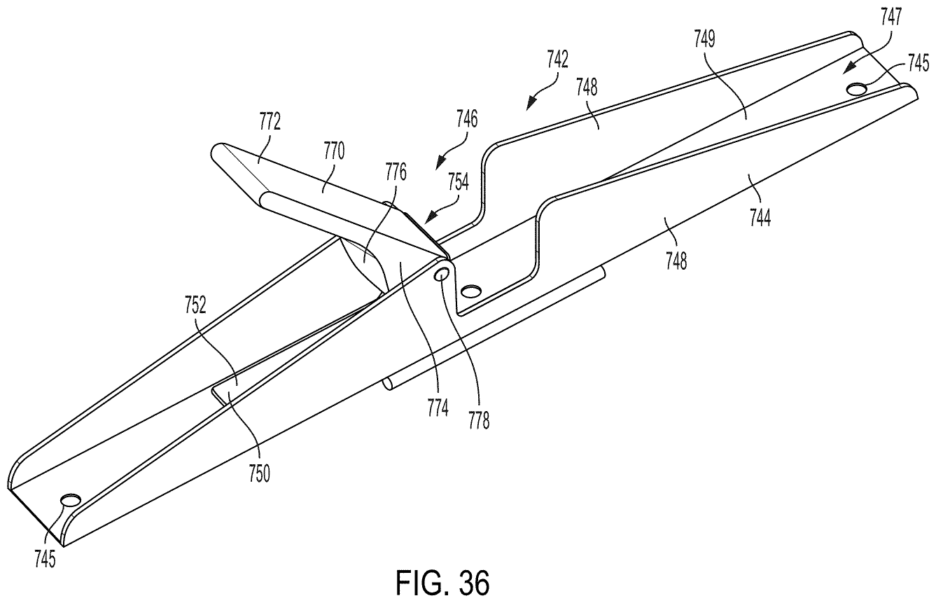

Portions of the table top clamp arrangement 742 are also shown in FIGS. 35 and 36. A pivot pin 778 of the locking lever 770 is depicted in an exploded view in FIG. 35 for clarity and in an assembled position in FIG. 36. Referring primarily to FIG. 35, the locking lever 770 includes a lever arm 772, a fulcrum 774 having a camming surface 776, and the pin 778 extending laterally through the fulcrum 774 and extending outward laterally therefrom. The pin 778 is press-fit in the fulcrum 774. The fulcrum 774 is eccentric with respect to the pin 778. In other words, the camming surface 776 is a variable distance from the axis defined by the pin 778.

In various instances, a single pin 778 can extend through the fulcrum 774 and opposing ends of the pin 778 can extend laterally outward from the fulcrum 774. In other instances, a pair of pins can be press fit, or otherwise partially embedded, in the fulcrum 774.

The locking lever 770 is retained by pin receptacles 769 in the sidewalls 748 of the bracket 744. For example, each pin receptacle 769 can be an aperture or through-hole that is configured to receive an end portion of the pin 778. When the locking lever 770 is pivotably secured to the sidewalls 748 of the bracket 744, the locking lever 770 can be positioned to operably engage the locking spring 750 mounted to the bracket 744.

The locking lever 770 can define a one-piece body, which is integrally formed or molded as a single component. In certain instances, the pin 778 can be press fit in an aperture in the locking lever 770. In other instances, the locking lever 770 can be molded over the pin 778.

In certain instances, the locking lever 770 can be made of a polymeric material. For example, the locking lever 770 can be made of one or more synthetic polymers and can be melt-processed. In certain instances, the locking lever 770 can be molded with nylon. A molded locking lever can include one or more cored-out cavities to reduce material costs, such as a series of small cavities along the lateral sides of the lever arm 772, for example.

In other instances, the locking lever 770 can be made of a metallic material. For example, the locking lever 770 can be made of aluminum. An aluminum locking lever can also include one or more cavities to reduce material costs, such as a large cavity in the fulcrum 774, for example.

In various instances, the locking lever 770 and the space 747 can be symbiotically designed such that the dimensions of the locking lever 770 are configured to cover a significant portion of the space 747 when the locking lever 770 is in the second orientation. For example, the width of the locking lever 770 can correspond to the space 747 between the opposing sidewalls 748, such that the locking lever 770 fits snuggly or closely between the opposing sidewalls 748. In such instances, the locking lever 770 can act as a shield, cover, or protective barrier, which can keep debris from entering that portion of the space 747 adjacent to the locking spring 750 and interfering with the operation of the table top clamp arrangement 742. For example, referring again to FIG. 32, the lever arm 772 is nestled between and recessed relative to the opposing sidewalls 748 within the space 747, i.e., below the edge of each sidewall 748. In such instances, the lever arm 772 can also be protected from accidental and/or unintentional actuations, for example.

Referring again to FIGS. 31 and 32, as the lever arm 772 is rotated and the locking lever 770 moves from the first orientation (FIG. 31) to the second orientation (FIG. 32), the fulcrum 774 rotates about the axis defined by the pin 778 and the camming surface 776 moves along the spring arm 754. In the second orientation, the camming surface 776 has compressed the spring arm 754 into the cavity 746 such that the locking spring 750 is in the second shape.

Owing to the eccentricity of the camming surface 776 relative to the pin 778, the locking lever 770 is clamped in the second orientation. For example, similar to the locking lever 670 (FIGS. 24, 25, and 28-30) the camming surface 776 can define a peak distance from the axis of rotation A defined by the pin 778 and the locking lever 770 can move the camming surface 776 through the peak distance to a lesser distance as the locking lever 770 moves between the first orientation (FIG. 31) and the second orientation (FIG. 32). Moving through the peak distance, e.g. over-center, can require an increased force to deform the locking spring 750 and, as a result, upon moving through the peak distance, the locking lever 770 can remain clamped, or locked, in the second orientation until an increased force is again applied to move the locking lever 770 back through the peak distance to the first orientation.

When the locking lever 770 is in the second orientation, the locking spring 750 can impart a spring back force onto the camming surface 776. However, owing to the eccentric orientation of the fulcrum 774 relative to the axis of rotation A, the locking spring 750 resists further rotation of the locking lever 770 effectively locking the locking lever 770 in place. In such instances, the locking lever 770 and the locking spring 750 can be self-locking when the locking lever 770 is in the second orientation because any rotation of the locking lever 770 away from the second orientation is resisted by the locking spring 750. Eccentric camming surfaces of a locking lever are further described herein with reference to FIGS. 37-42, for example.

When an elongate support 120 extends through the cavity 746, the locking lever 770 is configured to deflect the locking spring 750 to directly clamp the elongate support 120 between the locking spring 750 and upstanding sidewalls 743 on the opposing side of the cavity 746. More specifically, the locking spring 750 clamps at least partially around a longitudinal portion of the elongate support 120, which has an arcuate profile. As a result, the elongate support 120 is clamped to the bracket 744.

The table top clamp arrangement 742 can be configured to securely clamp or lock an elongate member, such as the elongate supports 120, to a table top, such as the table top 140, to assemble a piece of furniture, such as the pieces of furniture 180, 280, 380, and 480, for example.

The table top clamp arrangement 742 can provide a robust and secure clamp throughout multiple cycles of clamping and unclamping. For example, the single moving component—the locking lever 770—positioned to directly contact, engage and actuate the clamping element—the locking spring 750—minimizes the moving components and interactions thereof to securely clamp and unclamp (or release) the elongate support 120 to the bracket 744 on the underside of a table top 140.

Referring primarily to FIGS. 37-39, a locking lever 870 is shown. The locking lever 870 is similar to the locking lever 670 in various aspects. The locking lever 870 can replace the locking lever 670 in the trestle clamp arrangement 610 in certain instances. For example, the locking lever 870 can be retained by the pin receptacles 669 (FIGS. 24 and 25 and 28-30) mounted to the opposing sidewall surfaces 607 of the horizontal frame member 604 within the cavity 605, for example.

The locking lever 870 includes a lever arm 872 and a fulcrum 874 having a camming surface 876. The locking lever 870 also include a cavity 873 to reduce the weight and volume of material. Plates can cover the cavity 873 in certain instances. For example, plates can be welded or otherwise secured to either side of the fulcrum 874 to conceal the cavity 873. In other instances, the locking lever 870 can include additional cavities or can be solid.

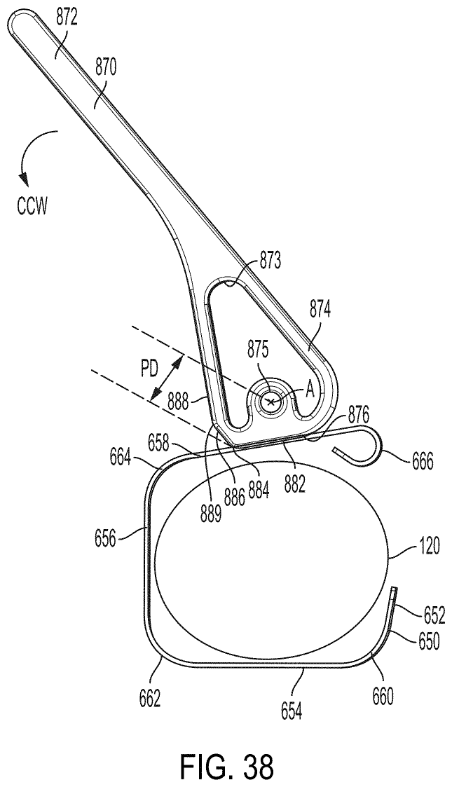

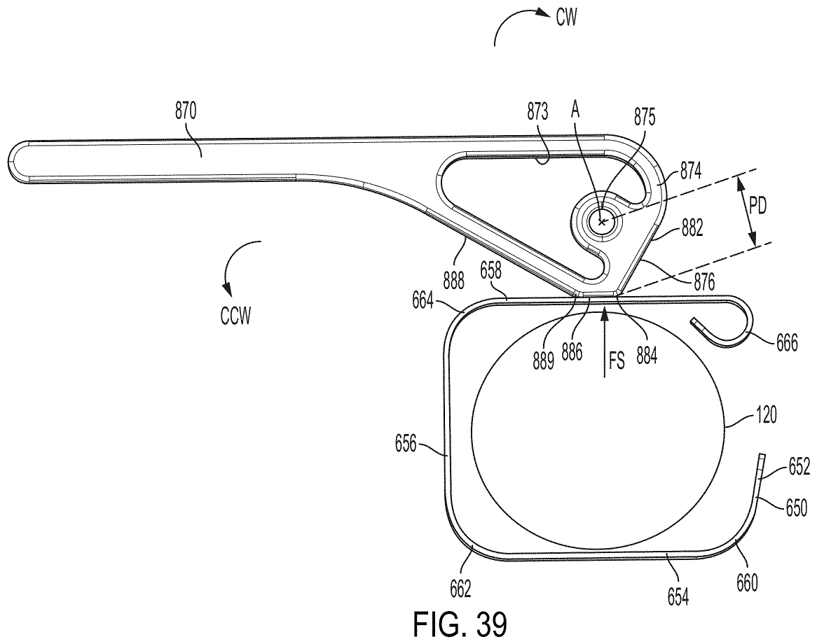

A pin like the pin 678 (FIGS. 24 and 25 and 28-30) can extend laterally through the fulcrum 874 and extend laterally outward from the fulcrum 874. For example, the pin can be press-fit in an aperture 875 through the fulcrum 874. In various instances, a single pin can extend through the fulcrum 874 and opposing ends of the pin can extend laterally outward from the fulcrum 874. In other instances, a pair of pins can be press fit, or at least partially embedded, in the fulcrum 874. The fulcrum 874 is eccentric with respect to the aperture 875 and the pin therein. In other words, the orthogonal distance between the camming surface 876 and the axis of rotation A (FIGS. 38 and 39) defined by the pin varies and includes a peak distance PD, as further described herein.

Referring still to FIGS. 37-39, the camming surface 876 of the locking lever 870 includes a first portion 882, a second portion 886, a first peak 884 between the first portion 882 and the second portion 886, a ramped surface 888 extending from the second portion 886 toward the lever arm 872, and a second peak 889 between the second portion 886 and the ramped surface 888. The peak distance PD is defined between the first peak 884 and the axis of rotation A.

Interactions between the locking spring 650 and the locking lever 870 are shown in FIGS. 38 and 39. In the first orientation (FIG. 38), which corresponds to an unclamped configuration of the trestle clamp arrangement, the first portion 882 of the camming surface 876 is engaged with the spring arm 658 of the locking spring 650 and the locking spring 650 is in a first shape (FIG. 38). As the locking lever 870 pivots about the axis of rotation A in a counterclockwise (CCVV) direction indicated in FIG. 38, the first peak 884 of the camming surface 876 moves along the spring arm 658 and deflects the locking spring 650, i.e. deflects the spring arm 658 toward the first portion 652 and the second portion 654 of the locking spring 650. Further rotation of the locking lever 870 in the CCW direction results in the first peak 884 deflecting the spring arm 658 until the axis of rotation A is a maximum or peak orthogonal distance PD from the spring arm 658. When the axis of rotation A is a maximum or peak orthogonal distance PD from the spring arm 658, the spring arm 658 is in a peak deflected state. Further rotation of the locking lever 870 in the CCW direction results in the second portion 886 of the camming surface 876 engaging the spring arm 658 and the spring arm 658 relaxing or rebounding from the peak deflected state into a second shape (FIG. 39). In other words, when the locking lever 870 is in the second orientation (FIG. 39), which corresponds to the clamped configuration, the second portion 886 of the camming surface 876 is engaged with the spring arm 658 of the locking spring 650 and the locking spring 650 conforms to the second shape (FIG. 39). The second portion 886 of the camming surface 876 comprises a flat surface which the spring arm 658 presses against. The “flat” of the second portion 886 helps to balance the locking lever 870 in the second orientation.

Referring primarily to FIG. 39, in the clamped configuration, the locking lever 870 and the locking spring 650 are self-locking and resist rotation out of the clamped configuration. Rotation of the locking lever 870 in a clockwise (CW) direction in FIG. 39— toward the first orientation of the locking lever 870 and an unclamped configuration of the trestle clamp arrangement—is restrained by the eccentric geometry of the fulcrum 874. Specifically, the spring arm 658 requires deflection to the peak deflected state by the first peak 884 in order to unlock the locking lever 870 from the clamped configuration. However, the spring back force FS generated by the locking spring 650 on the second portion 886 of the camming surface 876 resists CW rotation of the locking lever 870 out of the clamped configuration.

Rotation of the locking lever 870 in the CCW direction in FIG. 39 is also restrained by the eccentric geometry of the fulcrum 874. Specifically, further CCW rotation of the locking lever 870 would require further deflection of the already-deflected spring arm 658 by the second peak 889 and/or ramped surface 888 on the fulcrum 874. However, the spring back force FS generated by the locking spring 650 on the second portion 886 of the camming surface 876 resists CCW rotation of the locking lever out of the clamped configuration.

Moreover, in the clamped configuration, the spring back force FS on locking lever 870 is aligned with the axis of rotation A and, thus, a moment is not generated. However, as the locking lever 870 is rotated away from the second orientation, for example in the CW direction, a moment force corresponding to the spring back force FS and a moment arm thereof biases the locking lever 870 back toward the first orientation.

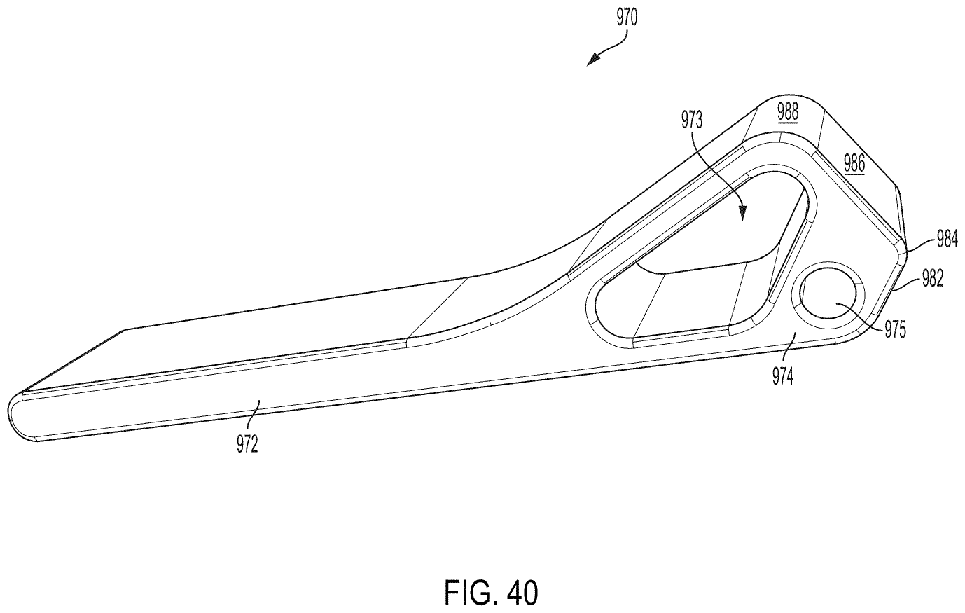

Referring primarily to FIGS. 40-42, a locking lever 970 is shown. The locking lever 970 is similar to the locking lever 770 in various aspects. The locking lever 970 can replace the locking lever 970 in the table top clamp arrangement 742 in certain instances. For example, the locking lever 970 can be retained by the pin receptacles 769 (FIGS. 33-35) in the sidewalls 748 of the bracket 744. For example, each pin receptacle 769 can be configured to receive an end portion of a pin through the locking lever 970. When the locking lever 970 is pivotably secured to the sidewalls 748 of the bracket 744, the locking lever 970 can be positioned to operably engage the locking spring 750 mounted to the bracket 744.

The locking lever 970 includes a lever arm 972 and a fulcrum 974 having a camming surface 976. The locking lever 970 also include a cavity 973 to reduce the weight and volume of material. Plates can cover the cavity 973 in certain instances. For example, plates can be welded or otherwise secured to either side of the fulcrum 974 to conceal the cavity 973. In other instances, the locking lever 970 can include additional cavities or can be solid.

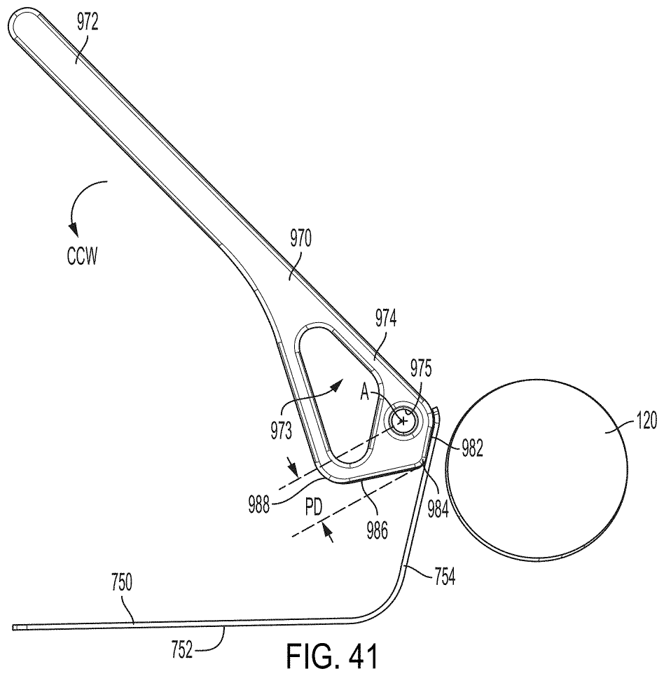

A pin like the pin 778 (FIGS. 30-32, 35 and 36) can extend laterally through the fulcrum 974 and extend laterally outward from the fulcrum 974. For example, the pin can be press-fit in an aperture 975 through the fulcrum 974. In various instances, a single pin can extend through the fulcrum 974 and opposing ends of the pin can extend laterally outward from the fulcrum 974. In other instances, a pair of pins can be press fit, or at least partially embedded, in the fulcrum 974. The fulcrum 974 is eccentric with respect to the aperture 975 and the pin therein. In other words, the orthogonal distance between the camming surface 976 and the axis of rotation A (FIGS. 40 and 41) defined by the pin varies and includes a peak distance PD, as further described herein.

Referring still to FIGS. 40-42, the camming surface 976 of the locking lever 970 includes a first portion 982, a second portion 986, a peak 984 between the first portion 982 and the second portion 986, and a bend 988 extending from the second portion 986 toward the lever arm 972. The peak distance PD is defined between the peak 984 and the axis of rotation A.

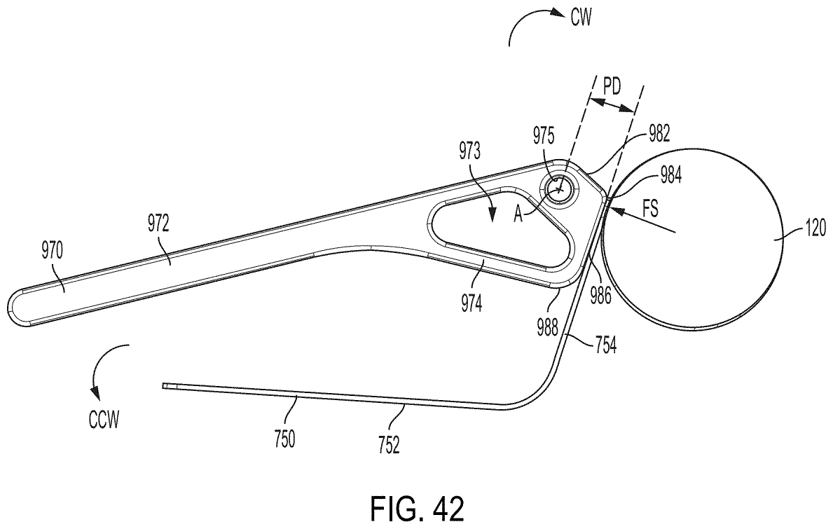

Interactions between the locking spring 750 and the locking lever 970 are shown in FIGS. 41 and 42. In the first orientation (FIG. 41), which corresponds to an unclamped configuration of the table top clamp arrangement, the first portion 982 of the camming surface 976 is engaged with the spring arm 754 of the locking spring 750 and the locking spring 750 is in a first shape (FIG. 41). As the locking lever 970 pivots about the axis of rotation A in a CCW direction indicated in FIG. 41, the peak 984 of the camming surface 876 moves along the spring arm 754 and deflects the locking spring 750, i.e. deflects the spring arm 754 away from the first portion 752 of the locking spring 750. Further rotation of the locking lever 970 in the CCW direction will result in the peak 984 deflecting the spring arm 754 until the axis of rotation A is a maximum or peak orthogonal distance PD from the spring arm 754. When the axis of rotation A is a maximum or peak orthogonal distance PD from the spring arm 754, the spring arm 754 is in a peak deflected state. Further rotation of the locking lever 970 in the CCW direction results in the second portion 986 of the camming surface 976 engaging the spring arm 754 and the spring arm 754 relaxing or rebounding from the peak deflected state into a second shape shown in FIG. 42. In other words, when the locking lever 970 is in the second orientation (FIG. 41), which corresponds to the clamped configuration, the second portion 986 of the camming surface 976 is engaged with the spring arm 754 of the locking spring 750 and the locking spring 750 conforms to the second shape (FIG. 42). The second portion 986 of the camming surface 976 comprises a flat surface which the spring arm 754 presses against. The “flat” of the second portion 986 helps to balance the locking lever 970 in the second orientation.

Referring primarily to FIG. 42, in the clamped configuration, the locking lever 970 and the locking spring 750 are self-locking and resist rotation out of the clamped configuration. Rotation of the locking lever 970 in a CW direction in FIG. 42—toward the first orientation of the locking lever 970 and an unclamped configuration of the table top clamp arrangement—is restrained by the eccentric geometry of the fulcrum 974. Specifically, the spring arm 754 requires deflection to the peak deflected state by the peak 984 in order to unlock the locking lever 970 from the clamped configuration. However, the spring back force FS generated by the locking spring 750 on the second portion 986 of the camming surface 976 resists CW rotation of the locking lever 970 out of the clamped configuration.

Rotation of the locking lever 970 in a CCW direction indicated in FIG. 42 is also restrained by the eccentric geometry of the fulcrum 974. Specifically, further CCW rotation of the locking lever 870 would require deflection of the spring arm 754 by the bend 988 on the fulcrum 974. However, the spring back force FS generated by the locking spring 750 on the second portion 986 of the camming surface 976 resists CCW rotation of the locking lever 970 out of the clamped configuration.

Moreover, in the clamped configuration, the spring back force FS on locking lever 970 is aligned with the axis of rotation A and, thus, a moment is not generated. However, as the locking lever 970 is rotated away from the second orientation, a moment force corresponding to the spring back force FS and a moment arm biases the locking lever 970 back toward the second orientation.

### EXAMPLES

Example 1—A clamping arrangement comprising a frame, a spring, a lever, and an elongate support. The frame comprises a first sidewall having a first through-hole, a second sidewall having a second through-hole, and a cavity intermediate the first sidewall and the second sidewall. The first through-hole and the second through-hole are axially aligned. The spring is positioned in the cavity. The spring comprises a folded sheet. The lever is pivotably coupled to the first sidewall and the second sidewall and pivotable between an unclamped position and a clamped position. The lever comprises a camming surface configured to deform the spring when in the clamped position. The elongate support extends through the first through-hole and the second through-hole. The spring is configured to clamp the elongate support when the lever is in the clamped position. The spring is configured to release the elongate support when the lever is in the unclamped position.

Example 2—The clamping arrangement of Example 1, wherein the lever is pivotably coupled to the first sidewall and the second sidewall about an axis of rotation, and wherein the orthogonal distance from the axis of rotation to the camming surface is variable.

Example 3—The clamping arrangement of Examples 1 or 2, wherein the lever is configured to pivot through a peak orthogonal distance between the unclamped position and the clamped position.

Example 4—The clamping arrangement of Examples 1, 2, or 3, wherein the folded sheet comprises a folded metal sheet.

Example 5—The clamping arrangement of Example 4, wherein the folded metal sheet comprises a central aperture, and wherein the central aperture is axially aligned with the first through-hole and the second through-hole.

Example 6—The clamping arrangement of Examples 4 or 5, wherein the folded metal sheet forms a C-shaped channel, and wherein the C-shaped channel is axially aligned with the first through-hole and the second through-hole.

Example 7—The clamping arrangement of Examples 1, 2, 3, 4, 5, or 6, wherein the cavity is defined between the first sidewall, the second sidewall, a first cavity-facing surface extending between the first sidewall and the second sidewall, and a second cavity-facing surface extending between the first sidewall and the second sidewall, and wherein the spring comprises a first planar portion abutting the first cavity-facing surface and a second planar portion abutting the second cavity-facing surface.

Example 8—The clamping arrangement of Examples 1, 2, 3, 4, 5, 6, or 7, wherein the cavity is dimensioned to receive the entire spring.

Example 9—The clamping arrangement of Examples 1, 2, 3, 4, 5, 6, 7, or 8, wherein the cavity is dimensioned to receive the entire lever when the lever is in the clamped position.

Example 10—The clamping arrangement of Examples 1, 2, 3, 4, 5, 6, 7, 8, or 9, wherein the camming surface comprises an eccentric camming surface.

Example 11—The clamping arrangement of Examples 1, 2, 3, 4, 5, 6, 7, 8, 9, or 10, wherein the frame comprises a trestle assembly for supporting a table top.

Example 12—The clamping arrangement of Examples 1, 2, 3, 4, 5, 6, 7, 8, 9, 10, or 11, wherein the first sidewall comprises a first pin receptacle plate, wherein the second sidewall comprises a second pin receptacle plate, and where the lever further comprises a fulcrum and a pin extending laterally through the fulcrum and engaged with the first pin receptacle plate and the second pin receptacle plate.

Example 13—A clamping arrangement comprising a frame, a spring, a lever, and an elongate support. The frame comprises a first sidewall having a first cutout, a second sidewall having a second cutout, and a cavity intermediate the first sidewall and the second sidewall. The first cutout and the second cutout are axially aligned. The spring is positioned in the cavity. The spring comprises a folded sheet. The lever is pivotably coupled to the first sidewall and the second sidewall and pivotable between an unclamped position and a clamped position. The lever comprises a camming surface configured to deform the spring when in the clamped position. The elongate support extends through the first cutout and the second cutout. The spring is configured to clamp the elongate support when the lever is in the clamped position. The spring is configured to release the elongate support when the lever is in the unclamped position.

Example 14—The clamping arrangement of Example 13, wherein the lever is pivotably coupled to the first sidewall and the second sidewall about an axis of rotation, and wherein the orthogonal distance from the axis of rotation to the camming surface is variable.

Example 15—The clamping arrangement of Examples 13 or 14, wherein the lever is configured to pivot through a peak orthogonal distance between the unclamped position and the clamped position.

Example 16—The clamping arrangement of Examples 13, 14, or 15, wherein the folded sheet comprises a folded metal sheet.

Example 17—The clamping arrangement of Example 16, wherein the cavity is defined between the first sidewall, the second sidewall, and a bottom surface extending between the first sidewall and the second sidewall, wherein the folded metal sheet forms an L-shape comprising a first planar portion adjacent to the bottom surface and a second planar portion adjacent to the elongate support.

Example 18—The clamping arrangement of Examples 13, 14, 15, 16, or 17, wherein the cavity is dimensioned to receive the entire spring and the entire lever when the lever is in the clamped position.

Example 19—The clamping arrangement of Examples 13, 14, 15, 16, 17, or 18, wherein the frame comprises a tabletop comprising an underside, and wherein the first sidewall and the second sidewall extend from the underside of the tabletop.

Example 20—A clamping arrangement comprising a frame, a spring, and a lever. The frame comprises a first sidewall having a first through-hole, a second sidewall having a second through-hole, and a cavity intermediate the first sidewall and the second sidewall. The first through-hole and the second through-hole are axially aligned. The spring is positioned in the cavity. The spring comprises a folded metal sheet. The lever comprises a camming surface. The lever is pivotably coupled to the first sidewall and the second sidewall about an axis of rotation and pivotable between an unclamped position and a clamped position. The lever is configured to pivot through a peak orthogonal distance from the axis of rotation to the camming surface when the lever is moved between the unclamped position and the clamped position. The camming surface is configured to directly engage the spring and deform the spring to a clamping configuration when the lever is in the clamped position.

Example 21—The clamping arrangement of Example 20, further comprising a cylindrical elongate support comprising a contoured outer perimeter, wherein the spring is configured to directly engage the contoured outer perimeter in the clamping configuration to clamp the elongate support to the frame.

While several forms have been illustrated and described, it is not the intention of Applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

It will be further appreciated that, for convenience and clarity, spatial terms such as “vertical”, “horizontal”, “up”, and “down” may be used herein with respect to the drawings. However, furniture can be positioned in many orientations and positions, and these terms are not intended to be limiting and/or absolute.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may sometimes be performed in any order. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

1. A clamping arrangement, comprising:
a frame, comprising:
a first sidewall having a first through-hole;
a second sidewall having a second through-hole, wherein the first through-hole and the second through-hole are axially aligned; and
a cavity intermediate the first sidewall and the second sidewall;
a spring positioned in the cavity, wherein the spring comprises a folded sheet;
a lever pivotably coupled to the first sidewall and the second sidewall and pivotable between an unclamped position and a clamped position, wherein the lever comprises a camming surface configured to deform the spring when in the clamped position; and
an elongate support extending through the first through-hole and the second through-hole, wherein the spring is configured to clamp on to the elongate support when the lever is in the clamped position, and wherein the spring is configured to release the elongate support when the lever is in the unclamped position.

2. The clamping arrangement of claim 1, wherein the lever is pivotably coupled to the first sidewall and the second sidewall about an axis of rotation, and wherein the orthogonal distance from the axis of rotation to the camming surface is variable.

3. The clamping arrangement of claim 2, wherein the lever is configured to pivot through a peak orthogonal distance between the unclamped position and the clamped position.

4. The clamping arrangement of claim 1, wherein the folded sheet comprises a folded metal sheet.

5. The clamping arrangement of claim 4, wherein the folded metal sheet comprises a central aperture, and wherein the central aperture is axially aligned with the first through-hole and the second through-hole.

6. The clamping arrangement of claim 4, wherein the folded metal sheet forms a C-shaped channel, and wherein the C-shaped channel is axially aligned with the first through-hole and the second through-hole.

7. The clamping arrangement of claim 4, wherein the cavity is defined between the first sidewall, the second sidewall, a first cavity-facing surface extending between the first sidewall and the second sidewall, and a second cavity-facing surface extending between the first sidewall and the second sidewall, and wherein the spring comprises:
a first planar portion abutting the first cavity-facing surface; and
a second planar portion abutting the second cavity-facing surface.

8. The clamping arrangement of claim 1, wherein the cavity is dimensioned to receive the entire spring.

9. The clamping arrangement of claim 8, wherein the cavity is dimensioned to receive the entire lever when the lever is in the clamped position.

10. The clamping arrangement of claim 1, wherein the camming surface comprises an eccentric camming surface.

11. The clamping arrangement of claim 1, wherein the frame comprises a trestle assembly for supporting a table top.

12. The clamping arrangement of claim 1, wherein the first sidewall comprises a first pin receptacle plate, wherein the second sidewall comprises a second pin receptacle plate, and where the lever further comprises a fulcrum and a pin extending laterally through the fulcrum and engaged with the first pin receptacle plate and the second pin receptacle plate.

13. A clamping arrangement, comprising:
a frame, comprising:
a first sidewall having a first cutout;
a second sidewall having a second cutout, wherein the first cutout and the second cutout are axially aligned; and
a cavity intermediate the first sidewall and the second sidewall;
a spring positioned in the cavity, wherein the spring comprises a folded sheet;
a lever pivotably coupled to the first sidewall and the second sidewall and pivotable between an unclamped position and a clamped position, wherein the lever comprises a camming surface configured to deform the spring when in the clamped position; and
an elongate support extending through the first cutout and the second cutout, wherein the spring is configured to clamp on to the elongate support when the lever is in the clamped position, and wherein the spring is configured to release the elongate support when the lever is in the unclamped position.

14. The clamping arrangement of claim 13, wherein the lever is pivotably coupled to the first sidewall and the second sidewall about an axis of rotation, and wherein the orthogonal distance from the axis of rotation to the camming surface is variable.

15. The clamping arrangement of claim 14, wherein the lever is configured to pivot through a peak orthogonal distance between the unclamped position and the clamped position.

16. The clamping arrangement of claim 13, wherein the folded sheet comprises a folded metal sheet.

17. The clamping arrangement of claim 16, wherein the cavity is defined between the first sidewall, the second sidewall, and a bottom surface extending between the first sidewall and the second sidewall, wherein the folded metal sheet forms an L-shape comprising:
a first planar portion adjacent to the bottom surface; and
a second planar portion adjacent to the elongate support.

18. The clamping arrangement of claim 13, wherein the cavity is dimensioned to receive the entire spring and the entire lever when the lever is in the clamped position.

19. The clamping arrangement of claim 13, wherein the frame comprises a tabletop comprising an underside, and wherein the first sidewall and the second sidewall extend from the underside of the tabletop.

20. A clamping arrangement, comprising:
a frame, comprising:
a first sidewall having a first through-hole;
a second sidewall having a second through-hole, wherein the first through-hole and the second through-hole are axially aligned; and
a cavity intermediate the first sidewall and the second sidewall;
a spring positioned in the cavity, wherein the spring comprises a folded metal sheet; and
a lever comprising a camming surface, wherein the lever is pivotably coupled to the first sidewall and the second sidewall about an axis of rotation and pivotable between an unclamped position and a clamped position, wherein the lever is configured to pivot through a peak orthogonal distance from the axis of rotation to the camming surface when the lever is moved between the unclamped position and the clamped position, and wherein the camming surface is configured to directly engage the spring and deform the spring to a clamping configuration when the lever is in the clamped position.

21. The clamping arrangement of claim 20, further comprising a cylindrical elongate support comprising a contoured outer perimeter, wherein the spring is configured to directly engage the contoured outer perimeter in the clamping configuration to clamp the elongate support to the frame.

22. The clamping arrangement of claim 1, wherein the spring is configured to clamp at least partially around the elongate support when the lever is in the clamped position.

23. The clamping arrangement of claim 13, wherein the spring is configured to directly clamp on to the elongate support when the lever is in the clamped position.

24. The clamping arrangement of claim 21, wherein the spring is configured to clamp at least partially around the cylindrical elongate support when the lever is in the clamping configuration.
